(19) United States
(12) Patent Application Publication
(10) Pub. No.: US 2020/0016583 A1
(43) Pub. Date: Jan. 16, 2020

(54) METHOD FOR PROVIDING A CATALYTICALLY ACTIVE FIXED BED FOR HYDROGENATING ORGANIC COMPOUNDS

(71) Applicant: BASF SE, Ludwigshafen am Rhein (DE)

(72) Inventors: Tobias Maximilian Merkel, Ludwigshafen (DE); Michael Schreiber, Ludwigshafen (DE); Irene de Wispelaere, Antwerpen (NL); Rolf Pinkos, Ludwigshafen (DE)

(21) Appl. No.: 16/335,897

(22) PCT Filed: Sep. 14, 2017
(86) PCT No.: PCT/EP2017/073146

§ 371 Date: Mar. 22, 2019

(30) Foreign Application Priority Data
Sep. 23, 2016 (EP) 16190429.7

(51) Int. Cl. B01J 35/04; B01J 25/02; B01J 23/883; B01J 35/00; B01J 35/10; B01J 37/02; B01J 37/06; B01J 37/08; B01J 37/18; B01J 35/02

(52) U.S. Cl. CPC B01J 35/04; B01J 25/02; B01J 23/883; B01J 35/0026; B01J 35/1076; B01J 37/0217; B01J 2208/024; B01J 37/0228; B01J 37/06; B01J 37/08; B01J 37/18; B01J 35/023; B01J 37/0225

(57) ABSTRACT

Described herein is a process for providing a catalytically active fixed bed for hydrogenation of organic compounds, in which a fixed bed including monolithic shaped bodies as catalyst supports or consisting of monolithic shaped bodies is introduced into a reactor and the fixed bed is then contacted with at least one catalyst or a precursor thereof. The fixed beds laden with a catalyst that are obtained in this way are especially suitable for the hydrogenation of organic compounds in the presence of CO, wherein the conversion is at least 90%. They are notable in that only a very small proportion, if any, of the catalyst introduced is released into the reaction medium.

### BACKGROUND OF THE INVENTION

The present invention relates to a process for providing a catalytically active fixed bed for hydrogenation of organic compounds, in which a fixed bed comprising monolithic shaped bodies as catalyst supports or consisting of monolithic shaped bodies is introduced into a reactor and the fixed bed is then contacted with at least one catalyst or a precursor thereof. The fixed beds laden with a catalyst that are obtained in this way are especially suitable for the hydrogenation of organic compounds in the presence of CO, wherein the conversion is at least 90%. They are notable in that only a very small proportion, if any, of the catalyst introduced is released into the reaction medium.

### PRIOR ART

It is known in principle that hydrogenation reactions can be conducted in the presence of carbon monoxide (CO). The CO may firstly be added to the hydrogen used for hydrogenation and/or originate from the feedstocks or the intermediates, by-products or products thereof. If catalysts comprising active components sensitive to CO are used for hydrogenation, a known countermeasure is that of conducting the hydrogenation at a high hydrogen pressure and/or a low catalyst hourly space velocity. Otherwise, the conversion can be incomplete, such that, for example, a postreaction in at least one further reactor is absolutely necessary. There can likewise be increased formation of by-products. Drawbacks associated with the use of high hydrogen pressures are the formation of methane resulting from hydrogenation of CO and hence elevated consumption of hydrogen and elevated capital costs.

U.S. Pat. No. 6,262,317 (DE 196 41 707 A1) describes the hydrogenation of butyne-1,4-diol with hydrogen in the liquid continuous phase in the presence of a heterogeneous hydrogenation catalyst at temperatures of 20 to 300° C., a pressure of 1 to 200 bar and values of the liquid-side volume-based mass transfer coefficient kLa of 0.1 s⁻¹ to 1 s⁻¹. The reaction can be effected either in the presence of a catalyst suspended in the reaction medium or in a fixed bed reactor operated in cocurrent in cycle gas mode. It is stated in quite general terms that it is possible to provide fixed bed reactors by directly coating structure packings as typically used in bubble columns with catalytically active substances. However, no further details of this are given. In the working examples, suspension catalysts or reactor packings based on Raschig rings having a diameter of 5 mm were used.

For hydrogenation in fixed bed mode, a ratio of gas stream supplied to gas stream leaving the reactor of 0.99:1 to 0.4:1 is described, meaning that at least 60% of the gas supplied is still present at the end of the reactor. In suspension mode, good hydrogenation results are described in example 1 with a space velocity of about 0.4 kg of butynediol/liter of reaction space×h. If the space velocity is increased to 0.7 (example 2), there is a decline in the butanediol yield and a rise in the proportion of unwanted by-products, such as 2-methylbutanediol, butanol and propanol. A problem with the hydrogenations in suspension is the handling of the suspended catalyst, which has to remain in the reactor, and so a filter system is absolutely necessary for retention of the catalyst. Filters of this kind have a tendency to become blocked with catalyst particles, and so they either have to be cleaned periodically in a costly and inconvenient manner or the running time is correspondingly short before passage through the filter becomes uneconomic. In examples 5 and 6 using supported catalysts too, a filter was still used in order to keep the particles of the catalyst bed in the reactor. The space velocity corresponded to about 0.25 kg of butynediol/liter of reaction space×h. The total amount of the 2-methylbutanediol, butanol and propanol by-products is relatively high at 6%. The implementation of the process described in U.S. Pat. No. 6,262,317 is technically complex for the reasons mentioned. Moreover, it is necessary in the case of fixed bed mode to provide a gaseous circulation stream, since at least 60% of the gas supply to the reactor exits again at the end of the reactor. In the case of such a cycle gas mode, however, the risk of accumulation of unwanted components in the gas stream is particularly high; this is particularly true of CO.

DE 199 629 07 A1 describes a process for preparing C₁₀-C₃₀-alkenes by partial hydrogenation of alkynes over fixed bed supported catalysts, wherein CO is added to the hydrogenation gas. The hydrogenation-active metal used is exclusively palladium. Suitable starting materials specifically mentioned are dehydrolinalool, hydrodehydrolinalool, 1-ethynyl-2,6,6-trimnethylcyclohexanol, 17-ethynylandrost-5-ene-3β,17β-diol, 3,7,11,15-tetramethyl-1-hexadecyn-3-ol (dehydroisophytol), 3,7,11-trimethyl-6-dodecen-1-yn-3-ol (dehydrodihydronerolidol), 4-methyl-4-hydroxy-2-decyne, 1,1-diethoxy-2-octyne and bis(tetrahydro-2-pyranyloxy)-2-butyne.

EP 0 754 664 A2 describes a process for preparing alkenes by partial hydrogenation of alkynes over fixed bed supported catalysts, wherein CO is added to the hydrogenation gas. The hydrogenation-active metal used is again exclusively palladium. A suitable reactant mentioned alongside a great multitude of others is butyne-1,4-diol. However, the working examples describe only the selective hydrogenation of 2-dehydrolinalool to 2-linalool.

DE 43 33 293 A1 describes partial hydrogenation of butyne-1,4-diol to butene-1,4-diol at 60° C. over a structured Pd catalyst. There is no mention of CO formation or the content thereof. There is also no statement of the amount of hydrogen which was utilized, but only of the pressure (15 bar). It can thus be assumed that the hydrogenation was not conducted continuously; instead, the reactant was merely pumped in circulation in trickle mode without any significant supply of hydrogen.

Known types of catalysts for hydrogenation reactions are precipitation catalysts, supported catalysts or Raney metal catalysts. Raney metal catalysts have found broad commercial use, specifically for hydrogenation of mono- or polyunsaturated organic compounds. Typically, Raney catalysts are alloys comprising at least one catalytically active metal and at least one alloy component soluble (leachable) in alkalis. Typical catalytically active metals are, for example, Ni, Fe, Co, Cu, Cr, Pt, Ag, Au and Pd, and typical leachable alloy components are, for example, Al, Zn and Si. Raney metal catalysts of this kind and processes for preparation thereof are described, for example, in U.S. Pat. Nos. 1,628,190, 1,915,473 and 1,563,587. Before they are used in heterogeneously catalyzed chemical reactions, specifically in a hydrogenation reaction, Raney metal alloys generally have to be subjected to an activation.

Standard processes for activating Raney metal catalysts comprise the grinding of the alloy to give a fine powder if it is not already in powder form as produced. For activation, the powder is subjected to a treatment with an aqueous alkali, with partial removal of the leachable metal from the alloy, leaving the highly active non-leachable metal. The powders thus activated are pyrophoric and are typically stored under water or organic solvents, in order to avoid contact with oxygen and associated deactivation of the Raney metal catalysts.

In a known process for activation of suspended Raney nickel catalysts, a nickel-aluminum alloy is treated with 15% to 20% by weight sodium hydroxide solution at temperatures of 100° C. or higher. U.S. Pat. No. 2,948,687 describes preparing a Raney nickel-molybdenum catalyst from a ground Ni—Mo—Al alloy having particle sizes in the region of 80 mesh (about 0.177 mm) or finer, by first treating the alloy at 50° C. with 20% by weight NaOH solution and raising the temperature to 100 to 115° C.

A crucial disadvantage of pulverulent Raney metal catalysts is the need to separate them from the reaction medium of the catalyzed reaction by costly sedimentation and/or filtration methods.

It is known that Raney metal catalysts can also be used in the form of coarser particles. For instance, U.S. Pat. No. 3,448,060 describes the preparation of structured Raney metal catalysts, wherein, in a first embodiment, an inert support material is coated with an aqueous suspension of a pulverulent nickel-aluminum alloy and freshly precipitated aluminum hydroxide. The structure thus obtained is dried, heated and contacted with water, releasing hydrogen. Subsequently, the structure is hardened. Leaching with an alkali metal hydroxide solution is envisaged as an option. In a second embodiment, an aqueous suspension of a pulverulent nickel-aluminum alloy and freshly precipitated aluminum hydroxide is subjected to shaping without use of a support material. The structure thus obtained is activated analogously to the first embodiment.

Further Raney metal catalysts suitable for use in fixed bed catalysts may include hollow bodies or spheres or have some other kind of support. Catalysts of this kind are described, for example, in EP 0 842 699, EP 1 068 900, U.S. Pat. Nos. 6,747,180, 2,895,819 and US 2009/0018366.

U.S. Pat. No. 2,950,260 describes a process for activating a catalyst composed of a granular nickel-aluminum alloy by treatment with an aqueous alkali solution. Typical particle sizes of this granular alloy are within a range of 1 to 14 mesh (about 20 to 1.4 mm). It has been found that the contacting of a Raney metal alloy, such as an Ni—Al alloy, with an aqueous alkali leads to an exothermic reaction with formation of relatively large amounts of hydrogen. The following reaction equations are intended to elucidate, by way of example, possible reactions which take place when an Ni—Al alloy is contacted with an aqueous alkali such as NaOH:

2NaOH+2Al+2H₂O→2NaAlO₂+3Hhd 2

2Al+6H₂O→2Al(OH)₃+3H₂

2Al(OH)₃→Al₂O₃+3H₂O

The problem addressed by U.S. Pat. No. 2,950,260 is that of providing an activated granular hydrogenation catalyst composed of an Ni—Al alloy with improved activity and service life. For this purpose, the activation is conducted with a 0.5% to 5% by weight NaOH or KOH, the temperature being kept below 35° C. by cooling and contact time being chosen such that not more than 1.5 molar parts of H₂ are released per molar equivalent of alkali. By contrast with a pulverulent suspended catalyst, a distinctly smaller proportion of aluminum is leached out of the structure in the case of treatment of granular Raney metal catalysts. This proportion is within a range of only 5% to 30% by weight, based on the amount of aluminum originally present. Catalyst particles having a porous activated nickel surface and an unchanged metal core are obtained. A disadvantage of the catalysts thus obtained, where only the outermost layer of the particles is catalytically active, is their sensitivity to mechanical stress or abrasion, which can lead to rapid deactivation of the catalyst. The teaching of U.S. Pat. No. 2,950,260 is restricted to granular shaped catalyst bodies, which differ fundamentally from larger structured shaped bodies. Moreover, this document also does not teach that the catalysts may additionally also comprise promoter elements in addition to nickel and aluminum.

It is known that hydrogenation catalysts, such as Raney metal catalysts, can be subjected to doping with at least one promoter element, in order thus to achieve, for example, an improvement in the field, selectivity and/or activity in the hydrogenation. In this way, it is generally possible to obtain products having improved quality. Dopings of this kind are described in U.S. Pat. Nos. 2,953,604, 2,953,605, 2,967,893, 2,950,326, 4,885,410 and 4,153,578.

The use of promoter elements serves, for example, to avoid unwanted side reactions, for example isomerization reactions. Promoter elements are additionally suitable for modifying the activity of the hydrogenation catalysts, in order to achieve, for example, in the case of hydrogenation of reactants having a plurality of hydrogenatable groups, either specific partial hydrogenation of a particular group or two or more particular groups or else full hydrogenation of all hydrogenatable groups. For example, it is known that it is possible to use, for partial hydrogenation of butyne-1,4-diol to butene-1,4-diol, a copper-modified nickel or palladium catalyst (see, for example, GB 832 141). In principle, the activity and/or selectivity of a catalyst can thus be increased or lowered by doping with at least one promoter metal. Such doping should as far as possible not adversely affect the other hydrogenation properties of the doped catalyst.

For modification of shaped catalyst bodies by doping, the following four methods are known in principle:
the promoter elements are already present in the alloy for preparation of the shaped catalyst bodies (method 1),
the shaped catalyst bodies are contacted with a dopant during the activation (method 2),
the shaped catalyst bodies are contacted with a dopant after the activation (method 3),
the shaped catalyst bodies are contacted with a dopant in the hydrogenation feed stream during the hydrogenation, or a dopant is introduced into the reactor during the hydrogenation in some other way (method 4).

The abovementioned method 1, in which at least one promoter is already present in the alloy for preparation of the shaped catalyst bodies, is described, for example, in U.S. Pat. No. 2,948,687 which has already been mentioned at the outset. According to this, to prepare the catalyst, a finely ground nickel-aluminum-molybdenum alloy is used in order to prepare a molybdenum-containing Raney nickel catalyst.

The abovementioned methods 2 and 3 are described, for example, in US 2010/0174116 A1 (=U.S. Pat. No. 8,889,911). According to this, a doped catalyst is prepared from an Ni/Al alloy, which is modified with at least one promoter metal during and/or after the activation thereof. In this case, the catalyst may optionally already have been subjected to a first doping prior to the activation. The promoter element used for doping by absorption on the surface of the catalyst during and/or after the activation is selected from Mg, Ca, Ba, Ti, Zr, Ce, Nb, Cr, Mo, W, Mn, Re, Fe, Co, Ir, Ni, Cu, Ag, Au, Bi, Rh and Ru. If the catalyst precursor has already been subjected to doping prior to the activation, the promoter element is selected from Ti, Ce, V, Cr, Mo, W, Mn, Re, Fe, Ru, Co, Rh, Ir, Pd, Pt and Bi.

The abovementioned method 3 is also described in GB 2104794. This document relates to Raney nickel catalysts for the reduction of organic compounds, specifically the reduction of carbonyl compounds and the preparation of butane-1,4-diol from butyne-1,4-diol. For preparation of these catalysts, a Raney nickel catalyst is subjected to doping with a molybdenum compound, which may be in solid form or in the form of a dispersion or solution. Other promoter elements, such as Cu, Cr, Co, W, Zr, Pt or Pd, may additionally be used. In a specific embodiment, an already activated commercially available undoped Raney nickel catalyst is suspended in water together with ammonium molybdate and the suspension is stirred until a sufficient amount of molybdenum has been absorbed. In this document, exclusively particulate Raney nickel catalysts are used for doping; specifically, there is no description of the use of structured shaped bodies. There is also no pointer as to how the catalysts can be introduced into a reactor in the form of a structured fixed catalyst bed and as to how the fixed catalyst bed introduced into the reactor can then be activated and doped.

The abovementioned method 4 is described, for example, in U.S. Pat. No. 2,967,893 or U.S. Pat. No. 2,950,326. According to this, copper is added in the form of copper salts to a nickel catalyst for the hydrogenation of butyne-1,4-diol under aqueous conditions.

According to EP 2 486 976 A1, supported activated Raney metal catalysts are subsequently doped with an aqueous metal salt solution. Specifically, the supports used are the bulk materials customary for the purpose, for example SiO₂-coated glass bodies having a diameter of about 3 mm. There is no description of conducting the doping and optionally even the activation beforehand over a fixed catalyst bed composed of structured shaped catalyst bodies present at a fixed location in a reactor. Thus, it is impossible by the process described in this document to provide a fixed catalyst bed having a gradient with respect to the concentration of the promoter elements in flow direction of the reaction medium of the reaction to be catalyzed.

EP 2 764 916 A1 describes a process for producing shaped foam catalyst bodies suitable for hydrogenations by:

a) providing a shaped metal foam body comprising at least one first metal selected, for example, from Ni, Fe, Co, Cu, Cr, Pt, Ag, Au and Pd,

b) applying at least one second leachable component or a component convertible to a leachable component by alloying, selected, for example, from Al, Zn and Si, to the surface of the shaped metal foam body, and

c) forming an alloy by alloying the shaped metal foam body obtained in step b) at least over part of its surface, and

d) subjecting the alloy obtained in the form of a foam in step c) to a treatment with an agent capable of leaching out the leachable component of the alloy.

This document teaches using 1 to 10 molar, i.e. 4% to 40% by weight, aqueous NaOH for step d). The temperature in step d) is 20 to 98° C., and the treatment time is 1 to 15 minutes. It is mentioned in quite general terms that the shaped foam bodies of the invention can also be formed in situ in a chemical reactor, but without any specific details. EP 2 764 916 A1 also teaches that it is possible to use promoter elements in the production of shaped foam catalyst bodies. The doping can be effected together with the application of the leachable component to the surface of the shaped metal foam body prepared beforehand. The doping can also be effected in a separate step after the activation.

EP 2 764 916 A1 does not contain the slightest details as to the dimensions of the chemical reactor for the use of the shaped foam bodies, the type, amount and dimensions of the shaped bodies introduced into the reactor, and the introduction of the shaped bodies into the reactor. More particularly, there is a lack of any detail as to how a real fixed catalyst bed present in a chemical reactor can first be activated and then doped.

It is an object of the present invention to provide an improved process for providing catalytically active fixed beds, which overcomes as many as possible of the aforementioned disadvantages.

It has been found that catalytically active fixed beds for hydrogenation of organic compounds can be produced particularly advantageously by introducing a fixed bed comprising monolithic shaped bodies as catalyst supports or consisting of monolithic shaped bodies into a reactor and then contacting the fixed bed with at least one catalyst or a precursor thereof. It has been found that, surprisingly, the fixed catalyst beds obtained in this way are notable for release of only very small proportions, if any, of the catalyst into the reaction medium of the reaction to be catalyzed. In general, based on the total weight of the liquid reaction medium, less than 1000 ppm by weight of catalyst are free in the liquid phase. This is surprising since, except for the introduction of the catalyst or precursors thereof in slurry form into the support packing, generally no further active measures are conducted in order to bring about physical or chemical binding of the catalyst to the support.

It has additionally been found that unsaturated organic compounds can advantageously be hydrogenated to saturated compounds when hydrogenation is effected using monolithic fixed bed catalysts and the CO content in the gas phase within the reactor is within a range from 0.1 to 10 000 ppm by weight, where the conversion is at least 90%.

### SUMMARY OF THE INVENTION

The invention provides a process for providing a catalytically active fixed bed comprising monolithic shaped bodies as catalyst supports or consisting of monolithic shaped bodies laden with a catalyst comprising at least one metal selected from Ni, Fe, Co, Cu, Cr, Pt, Ag, Au, Pd, Mn, Re, Ru, Rh and Ir, in which

a) a fixed bed comprising monolithic shaped bodies or consisting of monolithic shaped bodies is introduced into a reactor,

b) the fixed bed is contacted with a suspension of the at least one catalyst or the precursor thereof in a liquid medium and the suspension of the at least one catalyst or the precursor thereof is at least partly conducted in a liquid circulation stream, the catalyst or the precursor comprising at least one metal selected from Ni, Fe, Co, Cu, Cr, Pt, Ag, Au, Pd, Mn, Re, Ru, Rh and Ir, to obtain a fixed bed laden with the catalyst or the precursor,

c) the laden fixed bed obtained in step b) is optionally subjected to an activation,

d) the laden fixed bed obtained in step b) or the activated fixed bed obtained in step c) is optionally subjected to a treatment with a wash medium selected from water, C₁-C₄-alkanols and mixtures thereof,

e) the fixed bed obtained after the activation in step c) or after the treatment in step d) is optionally contacted with a dopant including at least one element other than the metal used for loading of the fixed bed.

### EMBODIMENTS OF THE INVENTION

1. A process for providing a catalytically active fixed bed comprising monolithic shaped bodies as catalyst supports or consisting of monolithic shaped bodies laden with a catalyst comprising at least one metal selected from Ni, Fe, Co, Cu, Cr, Pt, Ag, Au, Pd, Mn, Re, Ru, Rh and Ir, in which
a) a fixed bed comprising monolithic shaped bodies or consisting of monolithic shaped bodies is introduced into a reactor,
b) the fixed bed is contacted with a suspension of the at least one catalyst or the precursor thereof in a liquid medium and the suspension of the at least one catalyst or the precursor thereof is at least partly conducted in a liquid circulation stream, the catalyst precursor comprising at least one metal selected from Ni, Fe, Co, Cu, Cr, Pt, Ag, Au, Pd, Mn, Re, Ru, Rh and Ir, to obtain a fixed bed laden with the catalyst or the precursor,
c) the laden fixed bed obtained in step b) is optionally subjected to an activation,
d) the laden fixed bed obtained in step b) or the activated fixed bed obtained in step c) is optionally subjected to a treatment with a wash medium selected from water, C₁-C₄-alkanols and mixtures thereof,
e) the fixed bed obtained after the activation in step c) or after the treatment in step d) is optionally contacted with a dopant including at least one element other than the metal used for loading of the fixed bed.

2. The process according to any of the preceding embodiments, wherein the reactor has an internal volume in the range from 0.1 to 100 m³, preferably from 0.5 to 80 m³.

3. The process according to any of the preceding embodiments, wherein the monolithic shaped catalyst bodies, based on the overall shaped body, have a smallest dimension in any direction of at least 0.3 cm, preferably at least 1 cm, preferably at least 2 cm, particularly at least 3 cm, especially at least 5 cm.

4. The process according to any of the preceding embodiments, wherein the fixed bed is contacted in step b) with a suspension of the at least one catalyst or the precursor thereof in a liquid medium, wherein the catalyst or precursor comprises at least one metal selected from Ni, Co, Cu, Re, Ru, Pt and Pd, preferably selected from Ni, Co, Cu, Re and Ru.

5. The process according to any of the preceding embodiments, wherein, in step b), at least 90% by weight of the at least one catalyst or the precursor thereof, based on the total weight of the catalyst of the precursor, has a particle size in the range from 0.1 to 200 μm, preferably in the range from 1 to 100 μm, especially in the range from 5 to 50 μm.

6. The process according to any of the preceding embodiments, wherein the bulk density of the catalyst used in step b) or precursor thereof is at least 0.8 g/mL, preferably at least 1 g/mL, especially at least 1.5 g/mL.

7. The process according to any of the preceding embodiments, wherein the bulk density of the catalyst used in step b) or precursor thereof is at most 10 g/mL.

8. The process according to any of the preceding embodiments, wherein the catalyst precursor thereof is selected from precipitation catalysts, supported catalysts and Raney metal catalysts and the precursors thereof.

9. The process according to any of the preceding embodiments, wherein the monolithic shaped bodies are in the form of a foam.

10. The process according to any of embodiments 1 to 11, wherein the fixed bed is contacted in step b) with an active catalyst.

11. The process according to embodiment 12, wherein the active catalyst is selected from catalysts which have been activated by subjecting them to a treatment with a reducing gas, preferably hydrogen, and Raney metal catalysts.

12. The process according to any of embodiments 1 to 11, wherein the fixed bed is contacted in step b) with a catalyst precursor comprising at least one metal in oxidic form and the laden fixed bed obtained in step b) is activated in step c) by subjecting it to a treatment with a reducing gas, preferably hydrogen.

13. The process according to any of embodiments 1 to 11, wherein the fixed bed is contacted in step b) with an alloy comprising at least one first metal selected from Ni, Fe, Co, Cu, Cr, Pt, Ag, Au and Pd, and comprising at least one second component selected from Al, Zn and Si, and the laden fixed bed obtained in step b) is activated in step c) by subjecting it to a treatment with an aqueous base.

14. The process according to any of the preceding embodiments, wherein the fixed bed has, in any section in the normal plane to flow direction through the fixed bed, based on the total area of the section, not more than 5%, preferably not more than 1% and especially not more than 0.1% free area that is not part of the shaped bodies.

15. The process according to any of the preceding embodiments, wherein the fixed bed comprises shaped bodies having channels, and wherein, in any section in the normal plane to flow direction through the fixed bed, at least 90% of the channels, more preferably at least 98% of the channels, have an area of not more than 3 mm².

16. The process according to any of the preceding embodiments, wherein the fixed bed is filled with monolithic shaped bodies to an extent of at least 95% of the reactor cross section over at least 90% length in flow direction through the fixed bed, preferably to an extent of at least 98% of the reactor cross section, especially at least 99% of the reactor cross section.

17. A process for according to any of the preceding claims, wherein the catalytically active fixed bed, after step b) or after step a) or after step d) or after step e), in a further step f) is reacted with a hydrogenatable organic compound and hydrogen in at least one and the CO content in the gas phase within the reactor during the step f) is within a range from 0.1 to 10 000 ppm by volume.

18. The process according to any of the preceding embodiments, wherein the hydrogenatable organic compound in step f) is selected from compounds having at least one carbon-carbon double bond, carbon-nitrogen double bond, carbon-oxygen double bond, carbon-carbon triple bond, carbon-nitrogen triple bond or nitrogen-oxygen double bond.

19. The process according to either of embodiments 17 and 18, wherein the hydrogenable organic compound is selected from butyne-1,4-diol, butene-1,4-diol, 4-hydroxybutyraldehyde, hydroxypivalic acid, hydroxypivalaldehyde, n-butyraldehyde, isobutyraldehyde, n-valeraldehyde, isovaleraldehyde, 2-ethylhex-2-enal, 2-ethylhexanal, the isomeric nonanals, cyclododeca-1,5,9-triene, benzene, furan, furfural, phthalic esters, acetophenone and alkyl-substituted acetophenones.

20. The process according to any of embodiments 17 to 19, wherein step f) is conducted continuously.

21. The process according to any of embodiments 17 to 20, wherein the conversion in step f) is at least 90 mol %, preferably at least 95 mol %, particularly at least 99 mol %, especially at least 99.5 mol %, based on the total molar amount of hydrogenatable compounds in the starting material used in step f).

22. The process according to any of embodiments 17 to 21, wherein, during the step f), the CO content in the gas phase within the reactor is within a range from 0.15 to 5000 ppm by volume, especially within a range from 0.2 to 1000 ppm by volume.

23. The process according to any of embodiments 17 and 12, wherein the reactor has a gradient with respect to the CO concentration in flow direction of the reaction medium through the catalytically active fixed bed.

24. The process according to any of embodiments 17 to 23, wherein the CO content on exit of the reaction medium from the catalytically active fixed bed is at least 5 mol %, preferably at least 25 mol % and especially at least 75 mol % higher than the CO content on entry of the reaction medium into the catalytically active fixed bed.

25. The process according to any of embodiments 17 to 24, wherein the flow rate of the liquid reaction mixture through the reactor comprising the catalytically active fixed bed is at least 30 m/h, preferably at least 50 m/h, especially at least 80 m/h.

26. The process according to any of embodiments 17 to 25, wherein the flow rate of the liquid reaction mixture through the reactor comprising the catalytically active fixed bed is at most 1000 m/h, preferably at most 500 m/h, especially at most 400 m/h.

27. The process according to any of embodiments 17 to 26, wherein the reaction mixture in step f) is at least partly conducted in a liquid circulation stream.

28. The process according to any of embodiments 17 to 27, wherein the ratio of reaction mixture conducted in the circulation stream to freshly supplied reactant stream is within a range from 1:1 to 1000:1, preferably from 2:1 to 500:1, especially from 5:1 to 200:1.

29. The process according to any of embodiments 17 to 28, wherein an output is withdrawn from the reactor and subjected to a gas/liquid separation to obtain a hydrogen-containing gas phase and a product-containing liquid phase.

30. The process according to any of embodiments 17 to 29, wherein the absolute pressure during step f) is preferably within a range from 1 to 330 bar, more preferably within a range from 5 to 100 bar, especially within a range from 10 to 60 bar.

31. The process according to any of embodiments 17 to 30, wherein the temperature during step f) is preferably within a range from 60 to 300° C., more preferably from 70 to 220° C., especially from 80 to 200° C.

32. The process according to any of embodiments 17 to 31, wherein the catalytically active fixed bed has a temperature gradient during step f).

33. The process according to any of embodiments 17 to 32, wherein the liquid stream leaving the reactor has less than 1000 ppm by weight, based on the total weight of the liquid stream, of undissolved solid components.

### DESCRIPTION OF THE INVENTION

In the context of the invention, a fixed bed is understood to mean a device installed into a reactor in the manner of a packing, through which the reaction mixture of a reaction mixture to be catalyzed can flow. The fixed bed serves for fixing of a catalyst. For this purpose, a fixed bed comprising monolithic shaped bodies as catalyst supports or consisting of monolithic shaped bodies is first introduced into a reactor (=step a)). The fixed bed is introduced into the reactor by installation of the shaped catalyst bodies at a fixed location. The fixed bed has a multitude of channels through which a liquid medium can flow. This also applies to the reaction mixture of the hydrogenation reaction (=step f)) after the loading of the fixed bed with the catalyst. After the fixed bed has been introduced into the reactor, the fixed bed can be contacted either with the already active catalyst or with a precursor of the catalyst (=step b)). This results in a fixed bed laden with the catalyst or the precursor. If an already active catalyst is introduced into the fixed bed, it is generally possible to dispense with a subsequent activation (=step c)). If a catalyst precursor is introduced into the fixed bed, this precursor can be converted to the active catalyst by subsequent activation in step c). A fixed bed comprising active catalyst is referred to as catalytically active fixed bed.

Introduction of a Fixed Bed Into a Reactor (Step a))

The fixed bed is introduced into the reactor, as already mentioned, by installation of the monolithic shaped bodies at a fixed location. For production of a suitable fixed bed, the monolithic shaped bodies can be installed alongside one another and/or one on top of another in the reactor interior. Processes for installation of packings, for example of shaped bodies, are known in principle to the person skilled in the art. For example, one or more layers of a catalyst support foam can be introduced into the reactor. Monoliths each consisting of a ceramic block may be stacked alongside one another and one on top of another in the reactor interior. It is essential to the invention that the reaction mixture of the hydrogenation reaction (=step f)) flows exclusively or essentially through the shaped bodies laden with the active catalyst and not past them. In order to assure flow with minimum bypassing, the monolithic shaped bodies can be sealed with respect to one another and/or with respect to the inner wall of the reactor by means of suitable devices. These include, for example, sealing rings, sealing mats, etc., consisting of a material inert under the treatment and reaction conditions.

Preferably, the monolithic shaped bodies are installed into the reactor in one or more essentially horizontal layers with channels which enable flow through the fixed bed in flow direction. In this case, the fixed bed enables such flow both in the case of loading with the catalyst or a precursor thereof and in the case of activation, washing, doping and in the case of use for hydrogenation. The incorporation is preferably effected in such a way that the fixed bed very substantially fills the reactor cross section. If desired, the fixed bed may also comprise further internals such as flow distributors, apparatuses for feeding in gaseous or liquid reactants, measuring elements, especially for temperature measurement, or inert packings.

For the hydrogenation by the process of the invention, suitable reactors in principle are pressure-resistant reactors as customarily used for exothermic heterogeneous reactions involving feeding in one gaseous and one liquid reactant. These include the generally customary reactors for gas-and liquid reactions, for example tubular reactors, shell and tube reactors and gas circulation reactors. A specific embodiment of the tubular reactors is that of shaft reactors. Reactors of this kind are known in principle to the person skilled in the art. More particularly, a cylindrical reactor having a vertical longitudinal axis is used, having, at the base or top of the reactor, an inlet apparatus or a plurality of inlet apparatuses for feeding in a reactant mixture comprising at least one gaseous and at least one liquid component. Substreams of the gaseous and/or the liquid reactant can be fed to the reactor additionally, if desired, via at least one further feed apparatus. The reaction mixture of the hydrogenation (=step f)) generally takes the form of a biphasic mixture having a liquid phase and a gaseous phase. It is also possible that two liquid phases are present as well as the gas phase, for example when further components are present in the hydrogenation.

The processes of the invention are specifically suitable for hydrogenations which are to be conducted on an industrial scale. Preferably, the reactor in that case has an internal volume in the range from 0.1 to 100 m³, preferably from 0.5 to 80 m³. The term “internal volume” relates to the volume including the fixed catalyst bed(s) present in the reactor and any further internals present. The technical advantages associated with the process of the invention are of course also manifested even in reactors with a smaller internal volume.

In the process of the invention, “monolithic” shaped bodies are used as catalyst supports. Monolithic shaped bodies in the context of the invention are structured shaped bodies suitable for production of immobile structured fixed beds. By contrast with particulate catalysts and catalyst supports, it is possible to use monolithic shaped bodies to create essentially coherent and seamless fixed beds. This corresponds to the definition of monolithic in the sense of “consisting of one piece”. The monolithic shaped bodies of the invention, by contrast with random catalyst beds, for example composed of pellets, in many cases feature a higher ratio of axial flow (longitudinal flow) to radial flow (crossflow). Monolithic shaped bodies correspondingly have channels in flow direction of the reaction medium of the hydrogenation reaction (=step f)). Particulate catalysts display the catalytically active sites generally on an outer surface. Fixed beds composed of monolithic shape bodies have a multitude of channels, with the catalytically active sites generally arranged at least partly at the surface of the channel walls. The reaction mixture of the hydrogenation reaction (=step f)) can flow through the channels of the catalytically active fixed bed in flow direction through the reactor.

Thus, there is generally more intense contacting of the reaction mixture with the catalytically active sites than in the case of random catalyst beds composed of particulate shaped bodies.

The monolithic shaped bodies used in accordance with the invention are not shaped bodies composed of individual catalyst bodies having a greatest longitudinal dimension in any direction of less than 1 cm. Such non-monolithic shaped bodies lead to fixed beds in the form of standard random catalyst beds. The monolithic shaped bodies used in accordance with the invention have a regular flat or three-dimensional structure and as such differ from supports in particle form which are used in the form of a random bed.

The monolithic shaped bodies used in accordance with the invention, based on the overall shaped body, have a smallest dimension in any direction of preferably at least 1 cm, more preferably at least 2 cm, even more preferably at least 3 cm, particularly at least 5 cm. The maximum value for the greatest dimension in any direction is uncritical in principle and generally results from the production process for the shaped bodies. For example, shaped bodies in the form of foams may be sheetlike structures having a thickness within a range from millimeters to centimeters, a width in the range from a few centimeters to a few hundred centimeters, and a length (as the greatest dimension in any direction) of up to several meters.

The monolithic shaped bodies used in accordance with the invention, by contrast with bulk materials, can preferably be combined in a form-fitting manner to form larger units or consist of units larger than bulk materials.

The monolithic shaped bodies used in accordance with the invention generally also differ from particulate catalysts or the supports thereof in that they are present in significantly fewer parts. For instance, in accordance with the invention, a fixed bed may be used in the form of a single shaped body. In general, however, several shaped bodies are used to produce a fixed bed. The monolithic shaped bodies used in accordance with the invention generally have extended three-dimensional structures. The shaped bodies used in accordance with the invention are generally permeated by continuous channels. The continuous channels may have any geometry; for example, they may be in a honeycomb structure. Suitable shaped bodies can also be produced by shaping flat support structures, for example by rolling or bending the flat structures to give three-dimensional figures. Proceeding from flat substrates, the outer shape of the shaped bodies can be adapted here in a simple manner to given reactor geometries.

It is a feature of the monolithic shaped bodies used in accordance with the invention that they can be used to produce fixed beds where controlled flow through the fixed catalyst bed is possible. Movement of the shaped bodies under the conditions of the catalyzed reaction, for example mutual friction of the shaped bodies, is avoided. The ordered structure of the shaped bodies and the resulting fixed bed results in improved options for the optimal operation of the fixed bed in terms of flow methodology.

The monolithic shaped bodies used in the process of the invention are preferably in the form of a foam, mesh, woven fabric, loop-drawn knitted fabric, loop-formed knitted fabric or another monolith. The term “monolithic shaped body” in the context of the invention also includes structures known as “honeycomb catalysts”.

In a specific embodiment, the shaped bodies are in the form of a foam. The shaped bodies may have any suitable outer shapes, for example cubic, cuboidal, cylindrical, etc. Suitable woven fabrics can be produced with different weave types, such as plain weave, body weave, Dutch weave, five-shaft satin weave or else other specialty weaves. Also suitable are wire weaves made from weavable metal wires, such as iron, spring steel, brass, phosphor bronze, pure nickel, Monel, aluminum, silver, nickel silver (copper-nickel-zinc alloy), nickel, chromium nickel, chromium steel, nonrusting, acid-resistant and high-temperature-resistant chromium nickel steels, and titanium. The same applies to loop-drawn and loop-formed knitted fabrics. It is likewise possible to use woven fabrics, loop-drawn knitted fabrics or loop-formed knitted fabrics made from inorganic materials, such as from Al₂O₃ and/or SiO₂. Also suitable are woven fabrics, loop-drawn knitted fabrics or loop-formed knitted fabrics made from polymers such as polyamides, polyesters, polyolefins (such as polyethylene, polypropylene), polytetrafluoroethylene, etc. The aforementioned woven fabrics, loop-drawn knitted fabrics or loop-formed knitted fabrics, but also other flat structured catalyst supports, can be shaped to form larger three-dimensional monoliths. It is likewise possible to construct monoliths not from flat supports but to produce them directly without intermediate stages, for example the ceramic monoliths known to those skilled in the art with flow channels.

Suitable shaped bodies are as described, for example, in EP-A-0 068 862, EP-A-0 198 435, EP-A 201 614 and EP-A 448 884.

For instance, EP 0 068 862 describes a monolithic shaped body comprising alternating layers of smooth and corrugated sheets in the form of a roll having channels, and wherein the smooth sheets comprise woven, loop-formingly knitted or loop-drawingly knitted textile materials and the corrugated sheets comprise a mesh material.

EP-A-0 198 435 describes a process for preparing catalysts, in which the active components and the promoters are applied to support materials by vapor deposition under ultrahigh vacuum. Support materials used are mesh- or fabric-type support materials which in themselves are also suitable for the process of the invention. The catalyst fabrics, for installation into the reactor, are combined to form “catalyst packages” and the shaping of the catalyst packages is adapted to the flow conditions in the reactor.

EP-A-0 201 614 describes a reactor for heterogeneously catalyzed chemical reactions, comprising at least one packing element consisting of corrugated sheets arranged parallel to the main flow axis of the reactor, the corrugation of which is inclined obliquely relative to the main flow axis and has opposed alignments in adjacent sheets, with at least one catalyst body in ribbon form arranged between adjacent corrugated sheets.

More preferably, the monolithic shaped bodies are in the form of a foam. Suitable in principle are polymer foams or metal foams having different morphological properties in terms of channel sizes and shapes, layer thicknesses, areal densities, geometric surface areas, porosities, etc., channels meaning apertures having at least two openings (and not dead ends). The production can be effected in a manner known per se. For example, a foam composed of an organic polymer can be coated by contacting with at least one metal and then the polymer can be removed, for example by pyrolysis or dissolution in a suitable solvent, to obtain a metal foam.

For coating with at least one metal or a precursor thereof, the foam composed of the organic polymer can be contacted with a solution or suspension comprising the metal.

This can be effected, for example, by the process of the invention. For example, it is possible to coat a polyurethane foam with the first metal and then pyrolyze the polyurethane foam. A polymer foam suitable for production of shaped bodies in the form of a foam preferably has a pore size in the range from 100 to 5000 μm, more preferably from 450 to 4000 μm and especially from 450 to 3000 μm. A suitable polymer foam preferably has a layer thickness of 5 to 60 mm, more preferably of 10 to 30 mm. A suitable polymer foam preferably has a density of 300 to 1200 kg/m³. The specific surface area is preferably within a range from 100 to 20 000 m²/m³, more preferably 1000 to 6000 m²/m³. The porosity is preferably within a range from 0.50 to 0.95.

Alternatively, for provision of a catalytically active fixed bed in the context of the invention, a monolithic shaped body in the form of a metal foam based on at least one first metal as catalyst support can be introduced into a reactor and then contacted by the process of the invention with a suspension of at least one catalyst or a precursor thereof. The catalyst or precursor here comprises at least one second metal selected from Ni, Fe, Co, Cu, Cr, Pt, Ag, Au, Pd, Mn, Re, Ru, Rh and Ir. The first and second metals may in principle be the same or different.

Contacting of the Fixed Bed with the Catalyst or a Precursor Thereof (Step b))

The catalysts preferably comprise at least one element selected from Ni, Co, Cu, Re, Ru, Pt and Pd. The catalysts more preferably comprise at least one element selected from Ni, Co, Cu, Re and Ru.

In a specific embodiment, the catalysts comprise Ni.

In a further specific embodiment, the catalytically active catalysts do not comprise any Pd. This is understood to mean that, for production of the catalytically active shaped bodies, no palladium is actively added, either as catalytically active metal or as promoter element or for provision of the shaped bodies which serve as support material.

Preferably, the monolithic shaped bodies laden with the catalyst or the precursor that are obtained in step b) comprise at least one metal selected from Ni, Fe, Co, Cu, Cr, Pt, Ag, Au, Pd, Mn, Re, Ru, Rh and Ir in an amount of at least 1% by weight, more preferably at least 2% by weight, especially at least 5% by weight, based on the total weight of the monolithic shaped bodies laden with the catalyst or the precursor.

Preferably, the monolithic shaped bodies laden with the catalyst or the precursor that are obtained in step b) comprise at least one metal selected from Ni, Fe, Co, Cu, Cr, Pt, Ag, Au, Pd, Mn, Re, Ru, Rh and Ir in an amount of at most 95% by weight, based on the total weight of the monolithic shaped bodies laden with the catalyst or the precursor.

Preferably, the catalyst or the precursor is contacted with the fixed bed in a liquid medium. Preferred liquid media are selected from water, water-miscible organic solvents and mixtures thereof. Particularly suitable liquid media are selected from water, C₁-C₄-alkanols and mixtures thereof. Suitable C₁-C₄-alkanols are methanol, ethanol, n-propanol, isopropanol, n-butanol and isobutanol. Specifically, the liquid medium comprises water or consists of water.

The fixed bed in step b), is contacted with a suspension of the catalyst or the precursor thereof in a liquid medium.

Preferably, the catalyst or the precursor is in pulverulent form.

Preferably, in step b), the fixed bed is contacted with an at least 0.1% by weight, preferably an at least 1% by weight and more preferably an at least 5% by weight suspension of the catalyst or the precursor thereof in a liquid medium.

Preferably, in step b), the fixed bed is contacted with the catalyst or the precursor at a temperature in the range from 10 to 100° C., more preferably from 20 to 80° C.

Preferably, in step b), the fixed bed is contacted with the catalyst or the precursor at a pressure in the range from 0.5 bar to 2 bar, more preferably 0.8 bar to 1.2 bar, especially at ambient pressure.

The contacting of the fixed bed with the at least one catalyst or a precursor thereof is in principle effected by conducting the catalyst or the precursor through the fixed bed in a liquid medium.

In step b), the catalyst or the precursor thereof is conducted at least partly in a liquid circulation stream. Suitable hydrogenation reactors for this purpose are in principle all those having liquid circulation, as described hereinafter.

The contacting of the fixed bed with at least one catalyst or a precursor thereof can be effected in liquid phase mode or trickle mode. Preference is given to liquid phase mode, wherein the catalyst or the precursor thereof is fed in on the liquid phase side of the fixed catalyst bed and, after passing through the fixed catalyst bed, is withdrawn at the top end.

When the contacting of the fixed bed with at least one catalyst or a precursor thereof in step b) is effected in liquid phase mode, the fixed bed provided in accordance with the invention is preferably also operated in fixed bed mode in the subsequent dehydrogenation. When the contacting of the fixed bed with at least one catalyst or a precursor thereof in step b) is effected in trickle mode, the fixed bed provided in accordance with the invention is preferably also operated in trickle mode in the subsequent dehydrogenation.

In a first embodiment, in step b), the fixed bed is contacted with at least one catalyst or a precursor thereof in trickle mode. In that case, in a vertically aligned reactor, the catalyst or the precursor thereof is fed into the reactor at the top end and conducted from the top downward through the fixed bed, and an output is removed below the fixed bed and recycled into the reactor at the top end. In this case, the stream discharged can be subjected to a workup, for example by removing a portion of the liquid medium depleted of catalyst or precursor or by feeding in fresh catalyst or precursor. In a second embodiment, in step b), the fixed bed is contacted with at least one catalyst or a precursor thereof in liquid phase mode. In that case, in a vertically aligned reactor, the catalyst or the precursor thereof is fed into the reactor at the liquid phase end and conducted from the bottom upward through the fixed bed, and an output is removed above the fixed bed and recycled into the reactor at the liquid phase end. In this case, the stream discharged can be subjected to a workup, for example by removing a portion of the liquid medium depleted of catalyst or precursor or by feeding in fresh catalyst or precursor.

In general, the desired amount of the catalyst or precursor thereof is introduced into the reactor in suspended form in a liquid medium until the catalyst or precursor thereof is retained in the monolith. This involves, for example, pumping the suspension in circulation through the reactor, in the course of which suspension may be only gradually absorbed by the monolith. It is also possible to gradually meter further catalyst or precursor thereof into this pumped circulation stream. During the introduction in slurry form, it is also already possible to introduce gas into the reactor. The duration of the introduction in slurry form is generally between 0.5 and 24 hours. The process of introduction in slurry form can also be repeated after commissioning of the fixed catalyst bed, for example after a fault in operation in which the catalyst has been partly released again, by simply pumping the catalyst in circulation only until it is present in the monolith again. Subsequently, the hydrogenation can be restarted.

Without being bound to a theory, it is possible to conceive of the loading of the fixed bed by the process of the invention like the interaction between a filter packing and a solid material to be filtered off. Depending on the pore size and the surface of the reactor, the solid material can be introduced at least partly into the fixed bed and be retained in the fixed bed owing to various mechanisms such as particle inertness, diffusion effects, electrostatics or barrier effects. The properties of the catalyst or the precursor which follow are of critical importance here.

Preferably, in step b), at least 90% by weight of the at least one catalyst or the precursor thereof, based on the total weight of the catalyst of the precursor, has a particle size in the range from 0.1 to 200 μm, preferably in the range from 1 to 100 μm, especially in the range from 5 to 50 μm.

Preferably, in step b), at least 95% by weight of the at least one catalyst or the precursor thereof, based on the total weight of the catalyst of the precursor, has a particle size in the range from 0.1 to 200 μm, particularly in the range from 1 to 100 μm, especially in the range from 5 to 50 μm.

Preferably, the bulk density of the catalyst used in step b) or precursor thereof is at least 0.8 g/mL, preferably at least 1 g/mL, especially at least 1.5 g/mL. It has been found that too little catalyst remains in the fixed bed when the bulk density is too low. The effect of this is that the space-time yields when the catalytically active fixed bed is used for hydrogenation are too low, as a result of which the process is economically disadvantaged. One example of catalysts or precursors having too low a bulk density are those based activated carbon as support material, since these generally have a bulk density of less than 0.8 g/mL.

Preferably, the bulk density of the catalyst used in step b) or precursor thereof is at most 10 g/mL.

The bulk density ρ_{b} (also referred to as apparent density) is the density (i.e. mass per unit volume) of a mix of a granular solid (bulk material) and a continuous fluid that fills the cavities between the particles. In the present case, the fluid is air. The bulk density ρ_{b} is thus defined analogously the density of gases, liquids and solids as the ratio of the mass m of the bed to the bed volume occupied. Methods of determining bulk density are known to those skilled in the art and are based on the weighing of the bulk material that assumes a predetermined bed volume.

It is undesirable for catalytically active fixed beds, during the hydrogenation, to release any great amount of solids, specifically of catalytically active particles, to the reaction medium. This firstly requires measures for catalyst retention in order that the catalyst is not discharged from the reactor with the circulation stream and/or the product withdrawn. This leads to an economic disadvantage. It is a feature of the catalytically active fixed beds obtained by the process of the invention that only a very small proportion of the catalyst introduced is released into the reaction medium. Preferably, during the hydrogenation (=step f)), the liquid stream leaving the catalyst comprises less than 1000 ppm by weight, more preferably less than 500 ppm by weight, especially less than 100 ppm by weight, based on the total weight of the liquid stream, of undissolved solid components. The amount of solids leached out of the catalytically active fixed bed can be determined, for example, via gravimetry or elemental analysis, by determining the content of the catalytically active metal component in the total amount of the liquid stream leaving the reactor.

Preferably, the catalyst precursor thereof is selected from precipitation catalysts, supported catalysts and Raney metal catalysts and the precursors thereof.

In a first variant, in step b), the fixed bed is contacted with an already active catalyst.

Preferably, the active catalyst in that case is selected from catalysts which have been activated by subjecting them to a treatment with a reducing gas, preferably hydrogen, and Raney metal catalysts.

Particularly preferred active catalysts which can be activated by subjecting them to a treatment with a reducing gas are known in principle to those skilled in the art. These include, for example, the customary activated catalysts including a metal, e.g. Cu, Ni or Co, on an inert support. Inert support materials used for the catalysts may be virtually any prior art materials as advantageously in the production of supported catalysts. The support materials are preferably selected in such a way that the catalysts of the aforementioned preferred particle sizes and/or bulk densities. Suitable supports are, for example, ZrO₂, TiO₂, SiO₂ (quartz), porcelain, magnesium oxide, tin dioxide, silicon carbide, rutile, Al₂O₃ (alumina), aluminum silicate, steatite (magnesium silicate), zirconium silicate, cerium silicate or mixtures of these support materials. Preferred support materials are zirconium dioxide, titanium dioxide, aluminum oxide and silicon dioxide. Silicon dioxide support materials used may be silicon dioxide materials of different origin and production, for example pyrogenically produced silicas or silicas from wet-chemical production, such as silica gels, aerogels or precipitated silicas.

In a second variant, the fixed bed is contacted in step b) with a catalyst precursor comprising at least one metal in oxidic form and the laden fixed bed obtained in step b) is activated in step c) by subjecting it to a treatment with a reducing gas, preferably hydrogen. Suitable metals in oxidic form are, for example, the oxides of Cu, Re, Ni, Co or Ru.

In a third variant, the fixed bed is contacted in step b) with an alloy comprising at least one first metal selected from Ni, Fe, Co, Cu, Cr, Pt, Ag, Au and Pd, and comprising at least one second component selected from Al, Zn and Si, and the laden fixed bed obtained in step b) is activated in step c) by subjecting it to a treatment with an aqueous base.

Activation (Step c))

The laden fixed bed obtained in step b) is optionally subjected to an activation.

In the first variant mentioned above in step b), the fixed bed is contacted with an already active catalyst. In this variant, an activation of the laden fixed bed can generally be dispensed with.

In the second variant mentioned above in step b), the fixed bed is activated by subjecting it to a treatment with a reducing gas, preferably hydrogen. Processes of this kind for activation of catalyst precursors are known to those skilled in the art. Preference is given to activation using a biphasic mixture comprising a gaseous phase consisting essentially of hydrogen and comprising a liquid phase. Suitable liquids are water, alcohols, hydrocarbons or mixtures thereof.

In the third variant mentioned above in step b), the fixed bed is activated by subjecting it to a treatment with an aqueous base.

Preference is given to alloys in which the first metal comprises Ni or consists of Ni. Preference is further given to alloys in which the second component comprises Al or consists of Al. A specific embodiment is that of alloys comprising nickel and aluminum.

Preferably, the shaped bodies used for activation, based on the total weight, have 60% to 95% by weight, more preferably 70% of 80% by weight, of a first metal selected from Ni, Fe, Co, Cu, Cr, Pt, Ag, Au and Pd.

Preferably, the shaped bodies used for activation, based on the total weight, have 5% to 40% by weight, more preferably 20% of 30% by weight, of a second component selected from Al, Zn and Si.

Preferably, the shaped bodies used for activation, based on the total weight, have 60% to 95% by weight, more preferably 70% of 80% by weight, of Ni.

Preferably, the shaped bodies used for activation, based on the total weight, have 5% to 40% by weight, more preferably 20% of 30% by weight, of Al.

Preferably, the activation removes 30% to 70% by weight, more preferably 40% to 60% by weight, of the second component from the shaped bodies, based on the original weight of the second component.

Preferably, the shaped bodies used for activation comprise Ni and Al, and the activation removes 30% to 70% by weight, more preferably 40% to 60% by weight, of the Al, based on the original weight.

The amount of the second component, for example aluminum, leached out of the shaped bodies can be determined, for example, via elemental analysis, by determining the content of the second component in the total amount of the laden aqueous base discharged and the wash medium. Alternatively, the determination of the amount of the second component leached out of the shaped catalyst bodies can be determined via the amount of hydrogen formed in the course of activation. If aluminum is used, the leaching-out of 2 mol of aluminum results in production of 3 mol of hydrogen in each case.

During the activation, the fixed bed is subjected to a treatment with an aqueous base as treatment medium, wherein the second (leachable) component of the shaped bodies is at least partly dissolved and removed from the shaped bodies. This treatment with the aqueous base proceeds exothermically, such that the fixed bed is heated as a result of the activation. The heating of the fixed bed is dependent on the concentration of the aqueous base used. If no heat is removed from the reactor by active cooling and it is instead transferred to the treatment medium such that an adiabatic mode of operation is implemented to a certain degree, a temperature gradient forms in the fixed bed during the activation, with increasing temperature in flow direction of the aqueous base. But when heat is removed from the reactor by active cooling, a temperature gradient forms in the fixed bed during the activation.

The activation of the fixed catalyst bed can be effected in liquid phase mode or trickle mode. Preference is given to liquid phase mode, wherein the fresh aqueous base is fed in on the liquid phase side of the fixed catalyst bed and, after passing through the fixed catalyst bed, is withdrawn at the top end.

After passing through the fixed catalyst bed, a laden aqueous base is obtained. The laden aqueous base has a lower concentration of base compared to the aqueous base prior to passage through the fixed catalyst bed and is enriched in the reaction products that have formed in the activation and are at least partly soluble in the base. These reaction products include, for example, in the case of use of aluminum as the second (leachable) component, alkali metal aluminates, aluminum hydroxide hydrates, hydrogen, etc. (see, for example, U.S. Pat. No. 2,950,260).

The statement that the fixed catalyst bed has a temperature gradient during the activation is understood in the context of the invention such that the fixed catalyst bed has this temperature gradient over a relatively long period of time in the overall activation. Preferably, the fixed catalyst bed has a temperature gradient until at least 50% by weight, preferably at least 70% by weight, especially at least 90% by weight, of the amount of aluminum to be removed from the shaped catalyst bodies has been removed. If the strength of the aqueous base used is not increased over the course of the activation and/or the temperature of the fixed catalyst bed is increased as a result of a lesser degree of cooling than at the start of the activation or external heating, the temperature differential between the coldest point in the fixed catalyst bed and the warmest point in the fixed catalyst bed will become increasingly smaller over the course of the activation and may then even assume the value of zero toward the end of the activation.

Preferably, the temperature differential between the coldest point in the fixed catalyst bed and the warmest point in the fixed catalyst bed is kept at not more than 50 K. To determine the temperature differential over the course of the fixed catalyst bed, it can be provided with customary measurement units for temperature measurement. To determine the temperature differential between the warmest point in the fixed catalyst bed and the coldest point in the fixed catalyst bed, in the case of a reactor without active cooling, it is generally sufficient to determine the temperature differential between the furthest point upstream in the fixed catalyst bed and the furthest point downstream in the fixed catalyst bed. In the case of an actively cooled reactor, it may be advisable to provide at least one further temperature sensor (for example 1, 2 or 3 further temperature sensor(s)) between the furthest point upstream in the fixed catalyst bed and the furthest point downstream in the fixed catalyst bed.

Preferably, the temperature differential between the coldest point in the fixed catalyst bed and the warmest point in the fixed catalyst bed is kept at not more than 40 K, preferably at not more than 25 K.

Preferably, the temperature differential between the coldest point in the fixed catalyst bed and the warmest point in the fixed catalyst bed at the start of activation is kept within a range from 0.1 to 50 K, preferably within a range from 0.5 to 40 K, especially within a range from 1 to 25 K. It is possible, at the start of the activation, first to initially charge an aqueous medium without base and then to feed in fresh base until the desired concentration has been attained. In this case, the temperature differential between the coldest point in the fixed catalyst bed and the warmest point in the fixed catalyst bed at the start of activation is understood to mean the juncture when the desired base concentration has been attained for the first time at the reactor entrance.

The parameter of the temperature gradient in the fixed catalyst bed can be controlled in a reactor without active cooling by choosing the amount and concentration of the aqueous base fed in according to the capacity of the medium used for activation. To control the parameter of the temperature gradient in the fixed catalyst bed in a reactor with active cooling, heat is removed by heat exchange in addition to the medium used for activation. Such removal of heat can be effected by cooling the medium used for activation in the reactor used and/or, if present, the liquid circulation stream.

Preferably, the monolithic shaped bodies are activated by subjecting them to a treatment with an aqueous base having a strength of not more than 3.5% by weight. Particular preference is given to the use of an aqueous base having a maximum strength of 3.0% by weight. Preferably, the shaped bodies are activated by subjecting them to a treatment with an aqueous base having a strength of 0.1% to 3.5% by weight, more preferably an aqueous base having a strength of 0.5% to 3.5% by weight. The concentration figure is based on the aqueous base prior to contact thereof with the shaped catalyst bodies. If the aqueous base is contacted just once with the shaped catalyst bodies for activation, the concentration figure is based on the fresh aqueous base. If the aqueous base is conducted at least partly in a liquid circulation stream for activation, fresh base can be added to the laden base obtained after the activation before it is reused for activation of the shaped bodies. In this context, the concentration values stated above apply analogously.

Compliance with the above-specified concentrations for the aqueous base affords shaped bodies of Raney metal catalysts having high activity and very good stability. This is especially true of the activation of fixed beds for hydrogenation reactions on an industrial scale. Surprisingly, the stated concentration ranges for the base are effective in avoiding an excessive temperature increase and the uncontrolled formation of hydrogen in the activation of the catalysts. This advantage is especially effective in reactors on the industrial scale.

In a preferred embodiment, the aqueous base used for activation is at least partly conducted in a liquid circulation stream. In a first embodiment, the reactor is operated in liquid phase mode with the catalyst to be activated. In that case, in a vertically aligned reactor, the aqueous base is fed into the reactor at the liquid phase end and conducted from the bottom upward through the fixed catalyst bed, and an output is removed above the fixed catalyst bed and recycled into the reactor at the liquid phase end. The discharged stream will preferably be subjected here to a workup, for example by removal of hydrogen and/or the discharge of a portion of the laden aqueous phase. In a second embodiment, the reactor is operated in trickle mode with the catalyst to be activated. In that case, in a vertically aligned reactor, the aqueous base is fed into the reactor at the top end and conducted from the top downward through the fixed catalyst bed, and an output is removed below the fixed catalyst bed and recycled into the reactor at the top end. The discharged stream is preferably again subjected here to a workup, for example by removal of hydrogen and/or the discharge of a portion of the laden aqueous phase. Preferably, the activation is effected in a vertical reactor in liquid phase mode (i.e. with a stream directed upward through the fixed catalyst bed). Such a mode of operation is advantageous when the formation of hydrogen during the activation also produces a low gas hourly space velocity, since it can be more easily removed overhead.

In a preferred embodiment, in addition to the base conducted in the liquid circulation stream, the fixed bed is supplied with fresh aqueous base. Fresh base can be fed into the liquid circulation stream or separately therefrom into the reactor. The fresh aqueous base may also have a higher concentration than 3.5% by weight if the base concentration after the mixing with the recycled aqueous base is not higher than 3.5% by weight.

The ratio of aqueous base conducted in the circulation stream to freshly supplied aqueous base is preferably within a range from 1:1 to 1000:1, more preferably from 2:1 to 500:1, especially from 5:1 to 200:1.

Preferably, the feed rate of the aqueous base (when the aqueous base used for activation is not being conducted in a liquid circulation stream) is not more than 5 L/min per liter of fixed bed, preferably not more than 1.5 L/min per liter of fixed bed, more preferably not more than 1 L/min per liter of fixed bed, based on the total volume of the fixed bed.

Preferably, the aqueous base used for activation is conducted at least partly in a liquid circulation stream and the feed rate of the freshly supplied aqueous base is not more than 5 L/min per liter of fixed bed, preferably not more than 1.5 L/min per liter of fixed bed, more preferably not more than 1 L/min per liter of fixed bed, based on the total volume of the fixed bed.

Preferably, the feed rate of the aqueous base (when the aqueous base used for activation is not being conducted in a liquid circulation stream) is within a range from 0.05 to 5 L/min per liter of fixed bed, more preferably within a range from 0.1 to 1.5 L/min per liter of fixed bed, especially within a range from 0.1 to 1 L/min per liter of fixed bed, based on the total volume of the fixed bed.

Preferably, the aqueous base used for activation is conducted at least partly in a liquid circulation stream and the feed rate of the freshly supplied aqueous base is within a range from 0.05 to 5 L/min per liter of fixed bed, more preferably within a range from 0.1 to 1.5 L/min per liter of fixed bed, especially within a range from 0.1 to 1 L/min per liter of fixed bed, based on the total volume of the fixed bed.

The control of the feed rate of the fresh aqueous base is an effective way of keeping the temperature gradient that results in the fixed bed within the desired range of values.

The flow velocity of the aqueous base through the reactor comprising the fixed bed is preferably at least 0.5 m/h, more preferably at least 3 m/h, especially at least 5 m/h, specifically at least 10 m/h.

In order to avoid mechanical stress on and abrasion of the newly formed porous catalyst metal, it may be advisable not to choose too high a flow velocity. The flow velocity of the aqueous base through the reactor comprising the fixed bed is preferably not more than 100 m/h, more preferably not more than 50 m/h, especially not more than 40 m/h.

The above-specified flow velocities can be achieved particularly efficiently when at least a portion of the aqueous base is conducted in a liquid circulation stream.

The base used for activation of the fixed bed is selected from alkali metal hydroxides, alkaline earth metal hydroxides and mixtures thereof. The base is preferably selected from NaOH, KOH and mixtures thereof. Specifically, the base used is NaOH. The base is used for activation in the form of an aqueous solution.

The procedure described above enables effective minimization of leaching of the catalytically active metal, such as nickel, during the activation. A suitable measure of the effectiveness of the activation and the stability of the Raney metal catalyst obtained is the metal content in the laden aqueous phase. In the case of use of a liquid circulation stream, the metal content in the circulation stream is a suitable measure of the effectiveness of the activation and the stability of the Raney metal catalyst obtained. Preferably, the nickel content during the activation in the laden aqueous base or, when the a liquid circulation stream is used for activation, in the circulation stream is not more than 0.1% by weight, more preferably not more than 100 ppm by weight, especially not more than 10 ppm by weight. The nickel content can be determined by means of elemental analysis. The same advantageous values are generally also achieved in the downstream process steps, such as the treatment of the activated fixed bed with a wash medium, the treatment of the fixed bed with a dopant, and the use in a hydrogenation reaction.

The process of the invention enables homogeneous distribution of the catalytically active Raney metal over the shaped bodies used and, overall, over the activated fixed bed used. Only a slight gradient, if any, forms with respect to the distribution of the catalytically active Raney metal in flow direction of the activation medium through the fixed bed. In other words, the concentration of catalytically active sites upstream of the fixed bed is essentially equal to the concentration of catalytically active sites downstream of the fixed bed. This advantageous effect is achieved especially when the aqueous base used for activation is at least partly conducted in a liquid circulation stream. The processes of the invention also enable homogeneous distribution of the second component that has been leached out, for example the aluminum, over the shaped bodies used and, overall, over the activated fixed bed obtained. Only a slight gradient, if any, forms with respect to the distribution of the second component that has been leached out in flow direction of the activation medium through the fixed bed.

A further advantage, when the aqueous base used for activation is at least partly conducted in a liquid circulation stream, is that the use amount of aqueous base required can be distinctly reduced. Thus, a straight pass of the aqueous base (without recycling) and the subsequent discharge of the laden base leads to a high demand for fresh base. The supply of suitable amounts of fresh base to the recycle stream ensures that sufficient base for the activation reaction is always present. For this purpose, distinctly smaller amounts are required overall.

After passage through the fixed bed, a laden aqueous base is obtained, having a lower base concentration compared to the aqueous base prior to passage through the fixed bed and enriched in the reaction products that are formed in the activation and are at least partly soluble in the base. Preferably, at least a portion of the laden aqueous base is discharged. It is thus possible, even if a portion of the aqueous base is conducted in a circulation stream, to avoid excessive dilution and accumulation of unwanted impurities in the aqueous base used for activation. Preferably, the amount of fresh aqueous base fed in per unit time corresponds to the amount of laden aqueous base discharged.

Preferably, an output of laden aqueous base is withdrawn and subjected to a gas/liquid separation to obtain a hydrogen-containing gas phase and a liquid phase. For gas/liquid separation, it is possible to use the apparatuses that are customary for the purpose are known to those skilled in the art, such as the customary separation vessels. The hydrogen-containing gas phase obtained in the phase separation can be discharged from the process and sent, for example, to thermal utilization. The liquid phase obtained in the phase separation, comprising the laden aqueous base output, is preferably at least partly recycled into the activation as liquid circulation stream. Preferably, a portion of the liquid phase obtained in the phase separation, comprising the laden aqueous base output, is discharged. It is thus possible, as described above, to avoid excessive dilution and accumulation of unwanted impurities in the aqueous base used for activation.

To control the progress of the activation and to determine the amount of the second component, for example aluminum, leached out of the shaped catalyst bodies, it is possible to determine the amount of hydrogen formed in the course of activation. If aluminum is used, the leaching-out of 2 mol of aluminum results in production of 3 mol of hydrogen in each case.

Preferably, the activation of the invention is effected at a temperature of not more than 50° C., preferably at a temperature of not more than 40° C.

Preferably, the activation of the invention is effected at a pressure in the range from 0.1 to 10 bar, more preferably from 0.5 to 5 bar, specifically at ambient pressure.

Treatment with a Wash Medium (Step d))

In the optional step d), the laden fixed bed obtained in step b) or the activated fixed bed obtained in step c) is optionally subjected to a treatment with a wash medium selected from water, C₁-C₄-alkanols and mixtures thereof.

Suitable C₁-C₄-alkanols are methanol, ethanol, n-propanol, isopropanol, n-butanol and isobutanol.

Preferably, the wash medium used in step d) comprises water or consists of water.

Preferably, in step d), the treatment with the wash medium is conducted until the wash medium effluent has a conductivity at a temperature of 20° C. of not more than 200 mS/cm, more preferably of not more than 100 mS/cm, especially of not more than 10 mS/cm.

Preferably, in step d), water is used as wash medium and the treatment with the wash medium is conducted until the wash medium effluent has a pH at 20° C. of not more than 9, preferably of not more than 8, especially of not more than 7.

Preferably, in step d), the treatment with the wash medium is conducted until the wash medium effluent has an aluminum content of not more than 5% by weight, more preferably of not more than 5000 ppm by weight, especially of not more than 500 ppm by weight.

Preferably, in step d), the treatment with the wash medium is conducted at a temperature in the range from 20 to 100° C., more preferably from 20 to 80° C., especially from 25 to 70° C.

Doping (Step e))

Doping refers to the introduction of extraneous atoms into a layer or into the base material of a catalyst. The amount introduced in this operation is generally small compared to the rest of the catalyst material. The doping alters the properties of the starting material in a controlled manner.

In a specific embodiment, the fixed catalyst bed obtained after the activation (i.e. after step c), if it is conducted) and optionally after the treatment with a wash medium (i.e. also after step d), if it is conducted) is contacted with a dopant including at least one element other than the first metal and the second component of the shaped catalyst bodies used in step a). Such elements are referred to hereinafter as “promoter elements”. Preferably, the contacting with the dopant is effected during and/or after the treatment of the activated fixed catalyst bed with a wash medium (i.e. during and/or after step d)).

The dopant used in accordance with the invention preferably comprises at least one promoter element selected from Ti, Ta, Zr, V, Cr, Mo, W, Mn, Re, Fe, Ru, Co, Rh, Ir, Ni, Pd, Pt, Cu, Ag, Au, Ce and Bi.

It is possible that the dopant comprises at least one promoter element which simultaneously fulfills the definition of a first metal in the context of the invention. Promoter elements of this kind are selected from Ni, Fe, Co, Cu, Cr, Pt, Ag, Au, Pd, Mn, Re, Ru, Rh and Ir. In this case, the monolithic shaped body, based on the reduced metal form, contains a majority (i.e. more than 50% by weight) of the first metal and a minority (i.e. less than 50% by weight) of a different metal as dopant. In stating the total amount of the first metal that the monolithic shaped catalyst body comprises, however, all metals that fulfill the definition of a first metal in the context of the invention are calculated with their full proportion by weight (irrespective of whether they act as hydrogenation-active component or as promoter).

In a specific embodiment, the dopant does not comprise any promoter element that fulfills the definition of a first metal in the context of the invention. Preferably, the dopant in that case comprises exclusively a promoter element or more than one promoter element selected from Ti, Ta, Zr, V, Mo, W, Bi and Ce.

Preferably, the dopant comprises Mo as promoter element. In a specific embodiment, the dopant comprises Mo as the sole promoter element.

More preferably, the promoter elements for doping are used in the form of their salts. Suitable salts are, for example, the nitrates, sulfates, acetates, formates, fluorides, chlorides, bromides, iodides, oxides or carbonates. The promoter elements separate of their own accord in their metallic form either because of their baser character compared to Ni or can be reduced to their metallic form by contacting with a reducing agent, for example hydrogen, hydrazine, hydroxylamine, etc. If the promoter elements are added during the activation operation, they may also be present in their metallic form. In this case, it may be advisable for formation of metal-metal compounds to subject the fixed catalyst bed, after the incorporation of the promoter metals, first to an oxidative treatment and then to a reductive treatment.

In a specific embodiment, the fixed catalyst bed is contacted with a dopant comprising Mo as promoter element during and/or after the treatment with a wash medium in step c). Even more specifically, the dopant comprises Mo as the sole promoter element. Suitable molybdenum compounds are selected from molybdenum trioxide, the nitrates, sulfates, carbonates, chlorides, iodides and bromides of molybdenum, and the molybdates. Preference is given to the use of ammonium molybdate. In a preferred embodiment, a molybdenum compound having good water solubility is used. A good water solubility is understood to mean a solubility of at least 20 g/L at 20° C. In the case of use of molybdenum compounds having lower water solubility, it may be advisable to filter the solution prior to the use thereof as dopant. Suitable solvents for doping are water, polar solvents other than water that are inert with respect to the catalyst under the doping conditions, and mixtures thereof. Preferably, the solvent used for doping are selected from water, methanol, ethanol, n-propanol, isopropanol, n-butanol, isobutanol and mixtures thereof.

Preferably, the temperature in the doping is within a range from 10 to 100° C., more preferably from 20 to 60° C., especially from 20 to 40° C.

The concentration of the promoter element in the dopant is preferably within a range from about 20 g/L up to the maximum possible amount of the dopant under the doping conditions. In general, the maximum amount used as a starting point will be a solution saturated at ambient temperature.

The duration of doping is preferably 0.5 to 24 hours.

It may be advantageous that the doping is effected in the presence of an inert gas. Suitable inert gases are, for example, nitrogen or argon.

In a specific embodiment, for doping of shaped catalyst foam bodies, a molybdenum source is dissolved in water and this solution is passed through the previously activated foam. In the case of use of hydrates of ammonium molybdate, for example (NH₄)₆Mo₇O₂₄×4 H₂O, the latter is dissolved in water and this solution is used. The usable amount depends greatly on the solubility of the ammonium molybdate and is not critical in principle. For practical purposes, less than 430 g of ammonium molybdate are dissolved per liter of water at room temperature (20° C.). If the doping is conducted at higher temperature than room temperature, it is also possible to use greater amounts. The ammonium molybdate solution is subsequently passed through the activated and washed foam at a temperature of 20 to 100° C., preferably at a temperature of 20 to 40° C. The duration of treatment is preferably 0.5 to 24 h, more preferably 1 to 5 h. In a specific execution, the contacting is effected in the presence of an inert gas, such as nitrogen. The pressure is preferably within a range from 1 to 50 bar, specifically about 1 bar absolute. Thereafter, the doped Raney nickel foam can be used for the hydrogenation either without further workup or after another wash.

The doped shaped catalyst bodies comprise preferably 0.01% to 10% by weight, more preferably 0.1% to 5% by weight, of promoter elements based on the reduced metallic form of the promoter elements and the total weight of the shaped catalyst bodies.

The fixed catalyst bed may comprise the promoter elements in essentially homogeneous or heterogeneous distribution with respect to the concentration thereof. In a specific embodiment, the fixed catalyst bed has a gradient with respect to the concentration of the promoter elements in flow direction. More particularly, the fixed catalyst bed comprises or consists of shaped Ni/Al catalyst bodies which are activated by the process of the invention and/or are doped with Mo, and has a gradient with respect to the Mo concentration in flow direction.

It is possible to obtain a fixed bed catalyst installed in a fixed position in a reactor, and comprising at least one promoter element in essentially homogeneous distribution of its concentration, i.e. not in the form of a gradient. For provision of such a fixed bed catalyst, it is possible to dope the catalyst not in installed form in the fixed bed reactor itself, optionally with circulation, which can give rise to a concentration gradient. Preferably, the doping in that case is effected in an external vessel without circulation and having infinite backmixing, for example a batch reactor without continuous input and output. On completion of doping and optionally washing, such catalysts can be installed in a fixed bed reactor with or without circulation and are thus present without gradients.

For provision of a fixed catalyst bed having a gradient in flow direction with respect to the concentration of the promoter elements, the procedure may be to pass a liquid stream of the dopant through the fixed catalyst bed. If the reactor has a circulation stream, it is alternatively or additionally possible to feed the dopant into the circulation stream in liquid form. In the case of such a procedure, a concentration gradient of the promoter elements in flow direction forms over the entire length of the fixed catalyst bed. If a decrease in the concentration of the promoter element in flow direction of the reaction medium of the reaction to be catalyzed is desired, the liquid stream of the dopant is passed through the fixed catalyst bed in the same direction as the reaction medium of the reaction to be catalyzed. If an increase in the concentration of the promoter element in flow direction of the reaction medium of the reaction to be catalyzed is desired, the liquid stream of the dopant is passed through the fixed catalyst bed in the opposite direction to the reaction medium of the reaction to be catalyzed.

In a first preferred embodiment, the activated fixed catalyst bed obtained by the process of the invention or a reactor comprising such activated fixed catalyst bed serves for hydrogenation of butyne-1,4-diol to obtain butane-1,4-diol. It has now been found that, surprisingly, in the hydrogenation, a particularly high selectivity is achieved when a fixed catalyst bed comprising Ni/Al catalyst which are activated by means of the process of the invention and/or are doped with Mo is used, wherein the concentration of molybdenum increases in flow direction of the reaction medium of the hydrogenation reaction. Preferably, the molybdenum content of the shaped catalyst bodies at the entrance of the reaction medium into the fixed catalyst bed is 0% to 3% by weight, more preferably 0% to 2.5% by weight, especially 0.01% to 2% by weight, based on metallic molybdenum and the total weight of the shaped catalyst bodies. Preferably, the molybdenum content of the shaped catalyst bodies at the exit of the reaction medium from the fixed catalyst bed is 0.1% to 10% by weight, more preferably 0.1% to 7% by weight, especially 0.2% to 6% by weight, based on metallic molybdenum and the total weight of the shaped catalyst bodies.

In a second preferred embodiment, the activated fixed catalyst bed obtained by the process of the invention or a reactor comprising such activated fixed catalyst bed serves for hydrogenation of butyraldehyde to obtain n-butanol. It has now been found that, surprisingly, in the hydrogenation, a particularly high selectivity is achieved when a fixed catalyst bed comprising Ni/Al catalyst which are activated by means of the process of the invention and/or are doped with Mo is used, wherein the concentration of molybdenum decreases in flow direction of the reaction medium of the hydrogenation reaction. Preferably, the molybdenum content of the shaped catalyst bodies at the entrance of the reaction medium into the fixed catalyst bed is 0.5% to 10% by weight, more preferably 1% to 9% by weight, especially 1% to 7% by weight, based on metallic molybdenum and the total weight of the shaped catalyst bodies. Preferably, the molybdenum content of the shaped catalyst bodies at the exit of the reaction medium from the fixed catalyst bed is 0% to 7% by weight, more preferably 0% to 5% by weight, especially 0.01% to 4.5% by weight, based on metallic molybdenum and the total weight of the shaped catalyst bodies.

It has been found that it is advantageous for the efficiency of the doping of Raney metal catalysts and specifically of Raney metal catalysts having a promoter element, specifically Mo, when the activated fixed catalyst bed, after the activation and before the doping, is subjected to a treatment with a wash medium. This is especially true when Raney nickel catalyst foams are used for the doping. It has especially been found that the adsorption of the molybdenum onto the shaped catalyst bodies is incomplete when, after activation, the content of aluminum that can be washed out is still too high. Preferably, therefore, before the doping in step e), the treatment with a wash medium is conducted in step d) until the wash medium effluent at a temperature of 20° C. has a conductivity of not more than 200 mS/cm. Preferably, in step d), the treatment with the wash medium is conducted until the wash medium effluent has an aluminum content of not more than 500 ppm by weight.

The activated fixed catalyst beds obtained by the process of the invention, comprising doped shaped catalyst bodies, generally feature high mechanical stability and long service lives. Nevertheless, the fixed bed catalyst is mechanically stressed when the components to be hydrogenated flow through it in the liquid phase. This can result in wear or the abrasion of the outer layers of the active catalyst species in the long term. If the Raney nickel foam catalyst has been produced by leaching and doping, the subsequently doped metal element is preferably on the outer active catalyst layers, which can likewise be abraded by mechanical stress caused by liquid or gas. If the promoter element is abraded, this can reduced activity and selectivity of the catalyst for consequence. It has now been found that, surprisingly, the original activity can be restored by conducting the doping operation again. Alternatively, the doping can also be added to the hydrogenation, in which case redoping is effected in situ (method 4).

Hydrogenation (Step f)

In the context of the invention, hydrogenation is understood quite generally to mean the reaction of an organic compound with addition of H₂ onto this compound. Preference is given to hydrogenating functional groups to the correspondingly hydrogenated groups.

These include, for example, the hydrogenation of nitro groups, nitroso groups, nitrile groups or imine groups to give amine groups. These further include, for example, the hydrogenation of aromatics to give saturated cyclic compounds. These further include, for example, the hydrogenation of carbon-carbon triple bonds to give double bonds and/or single bonds. These further include, for example, the hydrogenation of carbon-carbon double bonds to give single bonds. These finally include, for example, the hydrogenation of ketones, aldehydes, esters, acids or anhydrides to give alcohols.

Preference is given to the hydrogenation of carbon-carbon triple bonds, carbon-carbon double bonds, aromatic compounds, compounds comprising carbonyl groups, nitriles and nitro compounds. Compounds comprising carbonyl groups suitable for hydrogenation are ketones, aldehydes, acids, esters and anhydrides.

Particular preference is given to the hydrogenation of carbon-carbon triple bonds, carbon-carbon double bonds, nitriles, ketones and aldehydes.

More preferably, the hydrogenatable organic compound is selected from butyne-1,4-diol, butene-1,4-diol, 4-hydroxybutyraldehyde, hydroxypivalic acid, hydroxypivalaldehyde, n- and isobutyraldehyde, n- and isovaleraldehyde, 2-ethylhex-2-enal, 2-ethylhexanal, the isomeric nonanals, cyclododeca-1,5,9-triene, benzene, furan, furfural, phthalic esters, acetophenone and alkyl-substituted acetophenones. Most preferably, the hydrogenatable organic compound is selected from butyne-1,4-diol, butene-1,4-diol, n- and isobutyraldehyde, hydroxypivalaldehyde, 2-ethylhex-2-enal, the isomeric nonanals and 4-isobutylacetophenone.

The hydrogenation of the invention leads the hydrogenated compounds which correspondingly no longer comprise the group to be hydrogenated. If a compound comprises at least 2 different hydrogenatable groups, it may be desirable to hydrogenate just one of the unsaturated groups, for example when a compound has an aromatic ring and additionally a keto group or an aldehyde group. This includes, for example, the hydrogenation of 4-isobutylacetophenone to 1-(4′-isobutylphenyl)ethanol or the hydrogenation of a C—C-unsaturated ester to the corresponding saturated ester.

In principle, simultaneously or instead of a hydrogenation in the context of the invention, an unwanted hydrogenation of other hydrogenatable groups may also occur, for example of carbon-carbon single bonds or of C—OH bonds to water and hydrocarbons. This includes, for example, the hydrogenolysis of butane-1,4-diol to propanal or butanol. These latter hydrogenations generally lead to unwanted by-products and are therefore undesirable. Preferably, the hydrogenation of the invention in the presence of a correspondingly activated catalyst features a high selectivity with respect to the desired hydrogenation reactions. These especially include the hydrogenation of butyne-1,4-diol or butene-1,4-diol to butane-1,4-diol. These further especially include the hydrogenation of n- and isobutyraldehyde to n- and isobutanol. These further especially include the hydrogenation of hydroxypivalaldehyde or of hydroxypivalic acid to neopentyl glycol. These further especially include the hydrogenation of 2-ethylhex-2-enal to 2-ethylhexanol. These further especially include the hydrogenation of nonanals to nonanols. These further especially include the hydrogenation of 4-isobutylacetophenone to 1-(4′-isobutylphenyl)ethanol.

The hydrogenation is preferably conducted continuously.

In the simplest case, the hydrogenation is effected in a single hydrogenation reactor. In a specific execution of the process according to the invention, the hydrogenation is effected in n series-connected hydrogenation reactors, where n is an integer of at least 2. Suitable values of n are 2, 3, 4, 5, 6, 7, 8, 9 and 10. Preferably, n is 2 to 6 and especially 2 or 3. In this execution, the hydrogenation is preferably effected continuously.

The reactors used for hydrogenation may have a fixed catalyst bed formed from identical or different shaped catalyst bodies. The fixed catalyst bed may have one or more reaction zones. Various reaction zones may have shaped catalyst bodies of different chemical composition of the catalytically active species. Various reaction zones may also have shaped catalyst bodies of identical chemical composition of the catalytically active species but in different concentration. If at least two reactors are used for hydrogenation, the reactors may be identical or different reactors. These may, for example, each have the same or different mixing characteristics and/or be divided once or more than once by internals.

Suitable pressure-resistant reactors for the hydrogenation are known to those skilled in the art. These include the generally customary reactors for gas-and liquid reactions, for example tubular reactors, shell and tube reactors and gas circulation reactors. A specific embodiment of the tubular reactors is that of shaft reactors.

The process of the invention is conducted in fixed bed mode. Operation in fixed bed mode can be conducted, for example, in liquid phase mode or in trickle mode.

The reactor is used for hydrogenation comprise a fixed catalyst bed activated by the process of the invention, through which the reaction medium flows. The fixed catalyst bed may be formed from a single kind of shaped catalyst bodies or from various shaped catalyst bodies. The fixed catalyst bed may have one or more zones, in which case at least one of the zones comprises a material active as a hydrogenation catalyst. Each zone may have one or more different catalytically active materials and/or one or more different inert materials. Different zones may each have identical or different compositions. It is also possible to provide a plurality of catalytically active zones separated from one another, for example, by inert beds or spacers. The individual zones may also have different catalytic activity. To this end, it is possible to use different catalytically active materials and/or to add an inert material to at least one of the zones. The reaction medium which flows through the fixed catalyst bed comprises at least one liquid phase. The reaction medium may also additionally comprise a gaseous phase.

During the hydrogenation, the CO content in the gas phase within the reactor is preferably within a range from 0.1 to 10 000 ppm by volume, more preferably within a range from 0.15 to 5000 ppm by volume, especially within a range from 0.2 to 1000 ppm by volume. The total CO content within the reactor is composed of the CO in the gas phase and liquid phase, which are in equilibrium with one another. For practical purposes, the CO content is determined in the gas phase and the values reported here relate to the gas phase.

A concentration profile over the reactor is advantageous, and the concentration of CO should rise in flow direction of the reaction medium of the hydrogenation along the reactor.

It has now been found that, surprisingly, a particularly high selectivity is achieved in the hydrogenation when the concentration of CO increases in flow direction of the reaction medium of the hydrogenation reaction. Preferably, the CO content at the exit of the reaction medium from the fixed catalyst bed is at least 5 mol % higher, more preferably at least 25 mol % higher, especially at least 75 mol % higher, than the CO content on entry of the reaction medium into the fixed catalyst bed. To produce a CO gradient in flow direction of the reaction mixture through the fixed catalyst bed, for example, CO can be fed into the fixed catalyst bed at one or more points.

The content of CO is determined, for example, by means of gas chromatography via taking of individual samples or preferably by online measurement. If samples are taken, it is especially advantageous upstream of the reactor to take both gas and liquid and expand them, in order that an equilibrium between gas and liquid has formed; the CO content is then determined in the gas phase.

The online measurement can be effected directly in the reactor, for example prior to entry of the reaction medium into the fixed catalyst bed and after exit of the reaction medium from the fixed catalyst bed.

The CO content can be adjusted, for example, by the addition of CO to the hydrogen used for the hydrogenation. Of course, CO can also be fed into the reactor separately from the hydrogen. When the reaction mixture of the hydrogenation is conducted at least partly in a liquid circulation stream, CO can also be fed into this circulation stream. CO can also be formed from components present in the reaction mixture of the hydrogenation, for example as reactants to be hydrogenated or as intermediates or by-products obtained in the hydrogenation. For example, CO can be formed by formic acid, formates or aldehyde present in the reaction mixture of the hydrogenation by decarbonylation. CO can likewise also be formed by decarbonylation of aldehydes other than formaldehyde or by dehydrogenation of primary alcohols to aldehydes and subsequent decarbonylation. These unwanted side reactions include, for example, C—C or C—X scissions, such as propanol formation or butanol formation from butane-1,4-diol. It has also been found that the conversion in the hydrogenation can be only inadequate when the CO content in the gas phase within the reactor is too high, i.e. specifically above 10 000 ppm by volume.

The conversion in the hydrogenation is preferably at least 90 mol %, more preferably at least 95 mol %, particularly at least 99 mol %, especially at least 99.5 mol %, based on the total molar amount of hydrogenatable compounds in the starting material used for hydrogenation. The conversion is based on the amount of the desired target compound obtained, irrespective of how many molar equivalents of hydrogen have been absorbed by the starting compound in order to arrive at the target compound. If a starting compound used in the hydrogenation comprises two or more hydrogenatable groups or comprises a hydrogenatable group that can absorb two or more equivalents of hydrogen (for example an alkyne group), the desired target compound may be the product either of a partial hydrogenation (e.g. alkyne to alkene) or of a full hydrogenation (e.g. alkyne to alkane).

It is important for the success of the hydrogenation of the invention that the reaction mixture of the hydrogenation (i.e. gas and liquid stream) flows very predominantly through the structured catalyst and does not flow past it, as is the case, for example, in conventional random fixed catalyst beds.

Preferably, more than 90% of the stream (i.e. of the sum total of gas and liquid stream) should flow through the fixed catalyst bed, preferably more than 95%, more preferably >99%.

The fixed catalyst beds used in accordance with the invention have, in any section in the normal plane to flow direction (i.e. horizontally) through the fixed catalyst bed, based on the total area of the section, preferably not more than 5%, more preferably not more than 1% and especially not more than 0.1% free area that is not part of the shaped catalyst bodies. The area of the pores and channels that open at the surface of the shaped catalyst bodies is not counted as part of this free area. The figure for free area relates exclusively to sections through the fixed catalyst bed in the region of the shaped catalyst bodies and not any internals such as flow distributors.

When the fixed catalyst beds used in accordance with the invention comprise shaped catalyst bodies having pores and/or channels, it is preferably the case that, in any section in the normal plane to flow direction through the fixed catalyst bed, at least 90% of the pores and channels, more preferably at least 98% of the pores and channels, have an area of not more than 3 mm².

When the fixed catalyst beds used in accordance with the invention comprise shaped catalyst bodies having pores and/or channels, it is preferably the case that, in any section in the normal plane to flow direction through the fixed catalyst bed, at least 90% of the pores and channels, more preferably at least 98% of the pores and channels, have an area of not more than 1 mm².

When the fixed catalyst beds used in accordance with the invention comprise shaped catalyst bodies having pores and/or channels, it is preferably the case that, in any section in the normal plane to flow direction through the fixed catalyst bed, at least 90% of the pores and channels, more preferably at least 98% of the pores and channels, have an area of not more than 0.7 mm².

In the fixed catalyst beds of the invention, preferably over at least 90% of the length in flow direction through the fixed catalyst bed, at least 95% of the reactor cross section, more preferably at least 98% of the reactor cross section, especially at least 99% of the reactor cross section, is filled with shaped catalyst bodies.

In order that good mass transfer takes place in the structure catalysts, the velocity with which the reaction mixture flows through the fixed catalyst bed should not be too low. Preferably, the flow velocity of the liquid reaction mixture through the reactor comprising the fixed catalyst bed is at least 30 m/h, preferably at least 50 m/h, especially at least 80 m/h. Preferably, the flow velocity of the liquid reaction mixture through the reactor comprising the fixed catalyst bed is at most 1000 m/h, preferably at most 500 m/h, especially at most 400 m/h.

The flow velocity of the reaction mixture, specifically in the case of an upright reactor, is not of critical significance in principle. The hydrogenation can be effected either in liquid phase mode or trickle mode. Liquid phase mode, wherein the reaction mixture to be hydrogenated is fed in at the liquid phase end of the fixed catalyst bed and is removed at the top end after passing through the fixed catalyst bed, may be advantageous. This is true particularly when the gas velocity should only low (e.g. <50 m/h). These flow velocities are generally achieved by recycling a portion of the liquid stream leaving the reactor again, combining the recycled stream with the reactant stream either upstream of the reactor or else within the reactor. The reactant stream can also be fed in divided over the length and/or width of the reactor.

In a preferred embodiment, the reaction mixture of the hydrogenation is at least partly conducted in a liquid circulation stream.

The ratio of reaction mixture conducted in the circulation stream to freshly supplied reactant stream is preferably within a range from 1:1 to 1000:1, more preferably from 2:1 to 500:1, especially from 5:1 to 200:1.

Preferably, an output is withdrawn from the reactor and subjected to a gas/liquid separation to obtain a hydrogen-containing gas phase and a product-containing liquid phase. For gas/liquid separation, it is possible to use the apparatuses that are customary for the purpose are known to those skilled in the art, such as the customary separation vessels (separators). The temperature in the gas/liquid separation is preferably just as high as or lower than the temperature in the reactor. The pressure in the gas/liquid separation is preferably just as high as or lower than the pressure in the reactor. Preferably, the gas/liquid separation is effected essentially at the same pressure as in the reactor. This is the case especially when the liquid phase and optionally the gas phase are conducted in a circulation stream. The pressure differential between reactor and gas/liquid separation is preferably not more than 10 bar, especially not more than 5 bar. It is also possible to configure the gas/liquid separation in two stages. The absolute pressure in the second gas/liquid separation in that case is preferably within a range from 0.1 to 2 bar.

The product-containing liquid phase obtained in the gas/liquid separation is generally at least partly discharged. The product of the hydrogenation can be isolated from this output, optionally after a further workup. In a preferred embodiment, the product-containing liquid phase is at least partly recycled into the hydrogenation as liquid circulation stream.

The hydrogen-containing gas phase obtained in the phase separation can be at least partly discharged as offgas. In addition, the hydrogen-containing gas phase obtained in the phase separation can be at least partly recycled into the hydrogenation. The amount of hydrogen discharged via the gas phase is 0 to 500 mol % of the amount of hydrogen which is consumed in molar terms of hydrogen in the hydrogenation. For example, in the case of consumption of one mole of hydrogen, 5 mol of hydrogen can be discharged as offgas. More preferably, the amount of hydrogen discharged via the gas phase is not more than 100 mol %, especially not more than 50 mol %, of the amount of hydrogen which is consumed in moles of hydrogen in the hydrogenation. By means of this discharge stream, it is possible to control the CO content in the gas phase in the reactor. In a specific execution, the hydrogen-containing gas phase obtained in the phase separation is not recycled. Should this be desired, however, this is preferably up to 1000% of the amount based on the amount of gas required in chemical terms for the conversion, more preferably up to 200%.

The gas loading, expressed in terms of the superficial gas velocity at the reactor exit, is generally not more than 200 m/h, preferably not more than 100 m/h, more preferably not more than 70 m/h, especially not more than 50 m/h. The gas loading consists essentially of hydrogen, preferably to an extent of at least 60% by volume. The gas velocity at the reactor inlet is extremely variable since hydrogen can also be added in intermediate feeds. If all the hydrogen is added at the reactor inlet, the gas velocity is generally higher than at the reactor outlet.

The absolute pressure in the hydrogenation is preferably within a range from 1 to 330 bar, more preferably within a range from 5 to 100 bar, especially within a range from 10 to 60 bar.

The temperature in the hydrogenation is preferably within a range from 40 to 300° C., more preferably from 70 to 220° C., especially from 80 to 200° C.

In a specific execution, the fixed catalyst bed has a temperature gradient during the hydrogenation. Preferably, the temperature differential between the coldest point in the fixed catalyst bed and the warmest point in the fixed catalyst bed is kept at not more than 50 K. Preferably, the temperature differential between the coldest point in the fixed catalyst bed and the warmest point in the fixed catalyst bed is kept within a range from 0.5 to 40 K, preferably within a range of 1 to 30 K.

The process of the invention offers an industrially readily implementable means of discharging possibly spent catalyst without needing to open the reactor. After shutting down the feeds and possibly purging to remove residual product from the reactor, the circulation stream is shut down and a suitable purge medium is used to purge the reactor in the opposite flow direction to the reaction to be catalyzed, purging the spent such as catalyst out of the packing. Thus, for example, purging is effected in trickle mode in the case of reaction in liquid phase mode. This can be effected, for example, with water or other suitable solvents such as alcohols, esters, ketones, hydrocarbons or mixtures thereof. Thus, it is advantageous to purge the reactor with the purge liquid and to conduct the catalyst that has been purged out of the reactor into a suitable collecting vessel. This can be effected at elevated temperatures, but preferably below 50° C. The amount of purge liquid depends on the nature of the packing and the catalyst; in general, purge volumes of 5 to 500 times the reactor volume are used. In this way, it is easily possible to remove more than 90% of the catalyst, which can then be replaced again by fresh catalyst.

The examples which follow serve to illustrate the invention, but without restricting it in any way.

### EXAMPLES

### Example 1: Hydrogenation of 4-isobutylacetophenone to 1-(4′-isobutylphenyl)ethanol

A wire mesh in the form of a plain weave, composed of an aluminum-containing ferritic chromium steel alloyed with yttrium and hafnium and having materials no. 1.4767, with a mesh size of 0.18 mm and a wire diameter of 0.112 mm, was partly corrugated by means of a toothed roller. This corrugated mesh was combined with a smooth fabric strip and coiled. This gave a monolithic shaped body which was fixed by point welding. The diameter of the coil was 2.5 cm, the length 20 cm. The monolith thus obtained was fitted into the apparatus used for the hydrogenations which is described hereinafter such that it was virtually impossible for the reaction mixture to pass along the edge between the fixed catalyst bed and in a reactor wall.

The hydrogenation apparatus consisted of a reservoir vessel, a feed pump, a compressed gas supply, a jacketed tubular reactor with an oil-heated jacket, a gas/liquid separator and a circulation pump. In the separator, the reactor output was separated into reactor offgas and liquid output, and the gas was discharged via a pressure-retaining valve and the liquid under level control (i.e. depending on the liquid level in the separator). The gas and reactant feed point was between the circulation pump and reactor inlet.

The plant was filled up with water to such an extent that a circulation stream (liquid circulation) in the apparatus was possible (about 20 liters/h, liquid phase mode). Subsequently, about 5 g of molybdenum-doped Raney nickel (BK111W, Evonik) slurried in 100 mL of water were introduced into the separator and pumped in circulation. After 3 h, sampling indicated that there was no Raney nickel in the circulation stream. Thereafter, still with a circulation flow rate of 20 liters/h, about 3 standard liters/h of hydrogen were fed in, the system was brought to pressure 40 bar and heated up to 60° C. A sample of the reactor output again showed that no Raney nickel was discharged. Thereafter, a feed of 4-isobutylacetophenone of 20 g/h was established. The offgas rate was about 0.4 standard liter/h. After an operating time of 48 h, analysis of the output showed a conversion of 4-isobutylacetophenone of 99.2% with a selectivity of greater than 99.6%. A secondary component obtained was 4-isobutylethylbenzene. The hydrogenation was operated for 10 days without occurrence of any impairment of catalyst activity and selectivity. Over the entire operating time, no Raney nickel was found in the circulation stream.

### Example 2: Hydrogenation of 4-isobutylacetophenone to 1-(4′-isobutylphenyl)ethanol

Analogously to example 1, rather than an Mo-doped Raney nickel, 5 g of a pulverized Cu catalyst (X 540 T, BASF Corporation, Florham Park, N.J. 07932, USA, sieve fraction between 10 and 50 μm, activated with H₂ at 180° C. in water) were converted to a slurry. Hydrogenation was effected as in example 1, except at 120° C. The conversion after 48 h was 99.5%, with a selectivity of 99.7%. As in example 1, no catalyst was found in the circulation stream over the entire hydrogenation period. After an operating time of 10 days, the hydrogenation was shut down, and the system was cooled down and decompressed. Thereafter, about 10 liters of water were purged through the top of the reactor and collected at the bottom of the reactor. About 95% of the catalyst was recovered in the purge water. By this method, a deactivated catalyst can easily be removed and then/catalyst can be introduced into the reactor.

### Example 3: Hydrogenation of butyne-1,4-diol

Sheets having a diameter of 2.5 cm were cut out of a commercially available nickel foam having a pore size of 580 μm, a thickness of 1.7 mm, a porosity of 90%, a geometric surface area of 6.9 m²/L and a surface density of 1150 g/cm² by means of a waterjet cutter, and 118 of them were installed in a stack having a height of about 20 cm into a reactor as defined in example 1. It was ensured that it was virtually impossible for the reaction mixture to pass along the edge between the fixed catalyst bed and in a reactor wall, and that there were no interstices between the sheets. As in example 1, after the reactor system had been filled with water, about 15 g of molybdenum-doped Raney nickel was subsequently introduced into the reactor in slurry form. Subsequently, the reactor was brought to 50 bar by means of hydrogen and heated up to 145° C., and then 15 standard liters of hydrogen/h were fed in. After 30 minutes with a circulation flow rate of 20 kg/h, there was no Raney nickel in the circulation stream. Then, for hydrogenation, 45 g/h of an aqueous butyne-1,4-diol feed material were metered in, having been prepared according to example 1 of EP 2121549 A1. The starting material had a pH of 7.5 and comprised, as well as butyne-1,4-diol and water, also about 1% by weight of propynol, 1.2% by weight of formaldehyde and a number of other by-products having proportions of well below 1% by weight. After a reaction time of 48 h, the output did not include any Raney nickel, the conversion was complete and consisted, according to GC analysis (area %, anhydrous) of about 94% butane-1,4-diol, 0.15% 2-methylbutanediol, 2.2% propanol, 1.9% butanol, 1.5% methanol and further components, but none above 500 ppm in terms of amount. The CO content at the reactor inlet was 2 ppm, and that at the outlet 25 ppm.

### Example 4: Hydrogenation of n-butyraldehyde

Analogously to example 3, n-butyraldehyde was hydrogenated to n-butanol at 40 bar and 130° C. At a feed rate of 50 g/h and a hydrogen flow rate of 20 standard liters/h, there was no catalyst in the output after 48 h. The following products were found (GC area %): 99.6% n-butanol, 0.05% butyl acetate, 0.01% dibutyl ether, 0.05% isobutanol and 0.07% ethylhexanediol. The CO content prior to entry into the reactor was 0.5 ppm and after exit from the reactor was 10 ppm.

### Example 5: Hydrogenation of 4-hydroxypivalaldehyde

Analogously to example 3, 4-hydroxypivalalaldehyde (HPA) were hydrogenated to neopentyl glycol (NPG). The feed contained (% by weight) about 10% HPA, about 25% water, 61% NPG, and collectively about 3.5% of the following components: isobutyraldehyde, formaldehyde, trimethylamine and its formate, hydroxypivalic acid NPG ester and further compounds in insignificant amounts. The pH was 8. Hydrogenation was effected at 135° C., a reactant feed rate of 150 g/h and a hydrogen feed rate of about 5 standard liters/h. After 48 h, there was no catalyst in the output and the HPA conversion was 96%. According to GC analysis, there was virtually exclusively conversion to NPG. The CO content prior to entry into the reactor was 0.2 ppm and after exit from the reactor was 15 ppm.

1. A process for providing a catalytically active fixed bed comprising monolithic shaped bodies as catalyst supports or consisting of monolithic shaped bodies laden with a catalyst comprising at least one metal selected from Ni, Fe, Co, Cu, Cr, Pt, Ag, Au, Pd, Mn, Re, Ru, Rh and Ir, in which
a) a fixed bed comprising monolithic shaped bodies or consisting of monolithic shaped bodies is introduced into a reactor,
b) the fixed bed is contacted with a suspension of the at least one catalyst or the precursor thereof in a liquid medium, and the suspension of the at least one catalyst or the precursor thereof is at least partly conducted in a liquid circulation stream, the catalyst or the precursor comprising at least one metal selected from Ni, Fe, Co, Cu, Cr, Pt, Ag, Au, Pd, Mn, Re, Ru, Rh and Ir, to obtain a fixed bed laden with the catalyst or the precursor,
c) the laden fixed bed obtained in step b) is optionally subjected to an activation,
d) the laden fixed bed obtained in step b) or the activated fixed bed obtained in step c) is optionally subjected to a treatment with a wash medium selected from water, C₁-C₄-alkanols, and mixtures thereof, and
e) the fixed bed obtained after the activation in step c) or after the treatment in step d) is optionally contacted with a dopant including at least one element other than the metal used for loading of the fixed bed.

2. The process according to claim 1, wherein the monolithic shaped catalyst bodies, based on the overall shaped body, have a smallest dimension in any direction of at least 0.3 cm.

3. The process according to claim 1, wherein, in step b), at least 90% by weight of the at least one catalyst or the precursor thereof, based on the total weight of the catalyst of the precursor, has a particle size in the range from 0.1 to 200 μm.

4. The process according to claim 1, wherein the bulk density of the catalyst used in step b) or precursor thereof is at least 0.8 g/mL.

5. The process according to claim 1, wherein the monolithic shaped bodies are in the form of a foam.

6. The process according to claim 1, wherein the fixed bed is contacted in step b) with an active catalyst, and wherein the active catalyst is selected from catalysts which have been activated by subjecting them to a treatment with a reducing gas and Raney metal catalysts.

7. The process according to claim 1, wherein the fixed bed is contacted in step b) with a catalyst precursor comprising at least one metal in oxidic form and the laden fixed bed obtained in step b) is activated in step c) by subjecting it to a treatment with a reducing gas.

8. The process according to claim 1, wherein the fixed bed is contacted in step b) with an alloy comprising at least one first metal selected from Ni, Fe, Co, Cu, Cr, Pt, Ag, Au and Pd, and comprising at least one second component selected from Al, Zn and Si, and the laden fixed bed obtained in step b) is activated in step c) by subjecting it to a treatment with an aqueous base.

9. The process according to claim 1, wherein the fixed bed has, in any section in the normal plane to flow direction through the fixed bed, based on the total area of the section, not more than 5% free area that is not part of the shaped bodies.

10. The process according to claim 1, wherein the fixed bed comprises shaped bodies having pores and/or channels, and wherein, in any section in the normal plane to flow direction through the fixed bed, at least 90% of the pores and channels have an area of not more than 3 mm².

11. The process according to claim 1, wherein the catalytically active fixed bed, after step b) or after step c) or after step d) or after step e), in a further step f) is reacted with a hydrogenatable organic compound and hydrogen in at least one reactor and the CO content in the gas phase within the reactor during the step f) is within a range from 0.1 to 10 000 ppm by volume.

12. The process according to claim 11, wherein the hydrogenable organic compounds in step f) are selected from butyne-1,4-diol, butene-1,4-diol, 4-hydroxybutyraldehyde, hydroxypivalic acid, hydroxypivalaldehyde, n-butyraldehyde, isobutyraldehyde, n-valeraldehyde, isovaleraldehyde, 2-ethylhex-2-enal, 2-ethylhexanal, the isomeric nonanals, cyclododeca-1,5,9-triene, benzene, furan, furfural, phthalic esters, acetophenone and alkyl-substituted acetophenones.

13. The process according to claim 11, wherein the reactor has a gradient with respect to the CO concentration in flow direction of the reaction medium through the catalytically active fixed bed.

14. The process according to claim 11, wherein the catalytically active fixed bed has a temperature gradient during the step f).

15. The process according to claim 2, wherein the monolithic shaped catalyst bodies, based on the overall shaped body, have the smallest dimension in any direction of at least 5 cm.

16. The process according to claim 3, wherein, in step b), at least 90% by weight of the at least one catalyst or the precursor thereof, based on the total weight of the catalyst of the precursor, has a particle size in the range from 5 to 50 μm.

17. The process according to claim 4, wherein the bulk density of the catalyst used in step b) or precursor thereof is at least 1.5 g/mL.

18. The process according to claim 9, wherein the fixed bed has, in any section in the normal plane to flow direction through the fixed bed, based on the total area of the section, not more than 0.1% free area that is not part of the shaped bodies.

19. The process according to claim 10, wherein the fixed bed comprises shaped bodies having pores and/or channels, and wherein, in any section in the normal plane to flow direction through the fixed bed, at least 98% of the pores and channels have an area of not more than 3 mm².
